(19) United States
(12) Patent Application Publication
(10) Pub. No.: US 2008/0174825 A1
(43) Pub. Date: Jul. 24, 2008

(54) SYSTEM AND A PROGRAM PRODUCT

(75) Inventor: Yuki Hatakeyama, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/961,825

(22) Filed: Dec. 20, 2007

(30) Foreign Application Priority Data
Jan. 19, 2007 (JP) 2007-010762

(51) Int. Cl. G06F 15/00

(52) U.S. Cl. 358/1.18

(57) ABSTRACT

A system controls at least one of a printer and a binder to perform processing for a case-binding job. The binder performs a case binding by attaching a cover to a bundle of sheets. The printer is used to print the cover which includes a spine region between a front-cover region and a back-cover region. A size of the spine region is selected based on a setting input by an operator via a user interface. The system inhibits the processing for the case-binding job by at least one of the printer and the binder, when a mismatch between the size of the spine region and thickness of the bundle of sheets is determined. On the other hand, when no mismatch is determined, the system permits the processing for the case-binding job by at least one of the printer and the binder.

### BACKGROUND OF THE INVENTION

1. Field of the Invention

The present invention relates to a system and a program product configured to enable a printer and/or a binder to perform processing for a case-binding job.

2. Description of the Related Art

In recent years, an increase in the speed of and improvement in image quality of an electrophotography printing apparatus or an ink jet printing apparatus have caused the emergence of a Print On Demand (POD) market.

In the POD market, for example, a printing apparatus, such as a digital multifunction apparatus or a digital copying machine, is maximally made use of, to achieve digital printing using electronic data, so that, for example, printing service can be performed. In view of such a situation, as in Japanese Patent Laid-Open No. 2005-165722, for example, business machine manufacturers are currently considering entering the new POD market. In particular, in recent years, printing apparatuses and printing systems that sufficiently satisfy, not only the needs and user cases of the office environment, but also the needs and user cases of the POD environment (differing from those of the office environment) are being considered.

When considering entering the POD market, it may be necessary to think about putting into practical use a digital printing system product that is also adapted to the POD environment.

However, when considering putting printing system products that are also adapted to the POD environment into practical use, there is still room for making various considerations, that is, there still exists problems to be solved and demands to be met.

For example, in the days ahead, the POD market and the like may strongly demand that a printing system that can perform case binding (as an operation for performing sizing/binding on a printed material) be put into practical use. Therefore, hereafter, considerations need to be increasingly made keeping in mind that products that can perform case binding are to be put into practical use. Here, it is desirable to consider a structure that, on the basis of information regarding the thickness of one sheet bundle for a printed material of a text, allows a front-cover image and a back-cover image to be disposed at a case-binding-cover (perfect-bound-cover) sheet.

Accordingly, as a print job for the aforementioned case binding, a layout of the front-cover image and the back-cover image, which are printed onto the case-binding-cover sheet, may be manually set by an operator through a user interface (UI). In addition, the case-binding printed material for the job (in which the layout of the images for the case-binding-cover sheet is manually set) is capable of being formed by a printing system. Such configurations also need to be considered. However, at present, such intensive considerations have not been actually made. Therefore, not only are there no solutions that allow, for example, the following problems to be solved, but also, at present, the following problems are not even recognized because the aforementioned intensive considerations are not even made.

For example, a printing system that is capable of forming a case-binding printed material in a job in which the layout of the images for the case-binding cover is manually set may be considered. In such a structure, as in the following Examples 1 and 2, a proper case-binding/printing result may not be obtained depending upon the setting of the layout manually set by the operator and the number of printed sheets of the printed material for a text.

Example 1 corresponds to the problem in which the output result indicates that the front-cover image and the back-cover image has moved into a spine.

Example 2 corresponds to the problem in which the output result indicates that the front-cover image and the back-cover image are printed at locations that are too distant from the spine.

Accordingly, regardless of the fact that a binding-related operation environment that is made very flexible for POD is provided, the provision of such an operating environment has given rise to additional problems such as those mentioned above. In such a POD environment, the problem that the printing system forms printed material which cannot be used as a product that meets the demands of a customer may arise.

### SUMMARY OF THE INVENTION

An embodiment of the present invention provides a process relating to case binding so as to reduce the occurrence of trouble caused by manually setting a size (e.g., width) of a spine region of a cover. In an embodiment, when a mismatch is determined between the thickness of a sheet bundle and the size of a spine region of a cover set by an operator via a user interface, processing for a case binding job performed by a printer and/or a binder is inhibited. In contrast, when no mismatch is determined between the thickness of the sheet bundle and the size of the spine region, the processing for the case binding job performed by the printer and the binder is permitted.

According to an aspect of the present invention, an embodiment is directed to a system configured to control at least one of a printer and a binder to perform processing for a case-binding job. The binder is adapted to perform a case binding by attaching a cover to a bundle of sheets. The cover includes a spine region between a front-cover region and a back-cover region on the same face. The printer is adapted to perform a case binding by printing front-cover data on the front-cover region and printing back-cover data on the back-cover region. A size (e.g., width) of the spine region is selected based on a setting input by an operator via a user interface. The system comprises: an inhibiter adapted to inhibit the processing for the case-binding job by at least one of the printer and the binder, when a mismatch between the size of the spine region and thickness of the bundle of sheets is determined; and a permitter adapted to permit the processing for the case-binding job by at least one of the printer and the binder, when no mismatch between the size of the spine region and thickness of the bundle sheets is determined.

Further features of the present invention will become apparent from, for example, the specification and the drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 illustrates an exemplary structure of the entire printing environment 10000 including a printing system 1000 that is controlled.

FIG. 2 illustrates an exemplary structure of the printing system 1000 that is controlled.

FIG. 3 is a side sectional view of an exemplary internal structure of the printing system 1000.

FIG. 4 is a side sectional view of an exemplary internal structure of a high-capacity stacker.

FIG. 5 is a side sectional view of an exemplary internal structure of a sizing/binding apparatus.

FIG. 6 is a side sectional view of an exemplary internal structure of a saddle-stitching/binding apparatus.

FIG. 7 shows an exemplary structure of an operating unit 204.

FIG. 8 shows an exemplary screen for selecting a sheet processing type.

FIG. 9 shows an exemplary screen for registering and setting a sheet processing apparatus.

FIG. 10 shows an exemplary screen for selecting a sheet processing type at a display unit of a computer.

FIG. 11 shows an exemplary flowchart conceptually illustrating operational steps in an embodiment.

FIG. 12 shows an exemplary flowchart of a first controlling operation procedure in the embodiment.

FIG. 13 illustrates an exemplary display control with respect to a UI unit that is controlled in the embodiment.

FIG. 14 illustrates another exemplary display control with respect to the UI unit that is controlled in the embodiment.

FIG. 15 illustrates still another exemplary display control with respect to the UI unit that is controlled in the embodiment.

FIG. 16 shows an exemplary control table that stores control information that is used to determine whether to permit or inhibit case binding in a job to be processed and that is controlled in the embodiment.

FIG. 17 shows another exemplary control table that stores control information that is used to determine whether to permit or inhibit case binding in a job to be processed and that is controlled in the embodiment.

FIG. 18 shows an exemplary flowchart of a second controlling operation procedure in the present invention.

FIGS. 19A to 19D are illustrations related to case binding in the embodiment.

FIG. 20 shows an exemplary control table that stores control information that is used to determine whether to permit or inhibit case binding in a job to be processed and that is controlled in the embodiment.

FIG. 21 illustrates an exemplary display control with respect to the UI unit that is controlled in the embodiment.

FIG. 22 is an illustration related to case binding in the embodiment.

FIGS. 23A to 23D are illustrations related to the case binding in the embodiment.

FIGS. 24A to 24D are illustrations related to the case binding in the embodiment.

FIGS. 25A to 25D are illustrations related to the case binding in the embodiment.

FIGS. 26A to 26D are illustrations related to the case binding in the embodiment.

FIGS. 27A to 27D are illustrations related to the case binding in the embodiment.

FIG. 28 is an exemplary flowchart of a third controlling operation procedure in the embodiment.

FIG. 29 shows an exemplary control table that stores control information that is used to determine whether to permit or inhibit case binding in a job to be processed and that is controlled in the embodiment.

FIG. 30 illustrates a memory map of a storage medium (recording medium) that stores various data processing programs used in the embodiment.

### DESCRIPTION OF THE EMBODIMENTS

Embodiments of the present invention will now be described in detail with reference to the drawings.

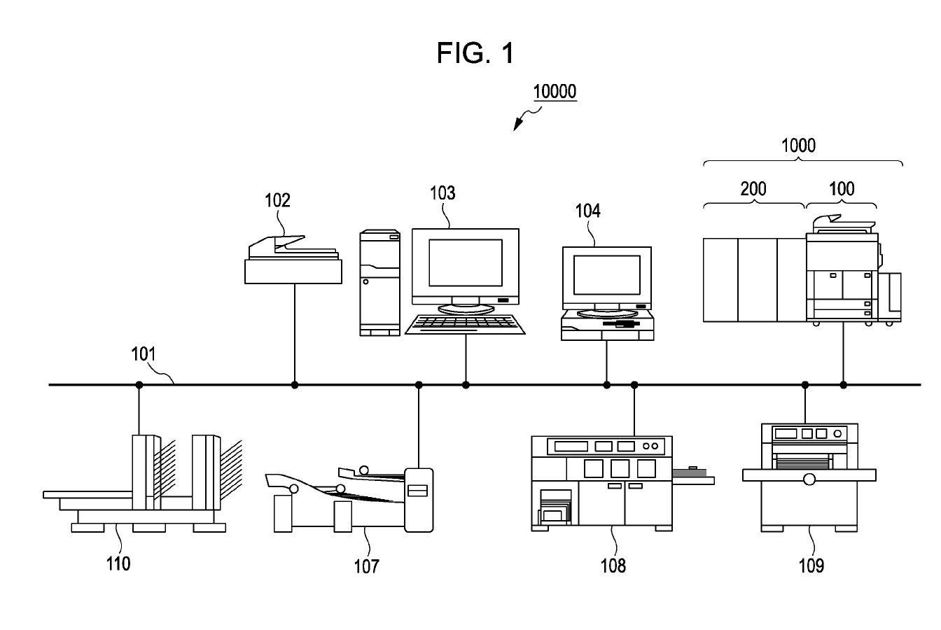

A POD system 10000 shown in FIG. 1 comprises a printing system 1000, a scanner 102, a server computer (PC) 103, a client computer (PC) 104, which are connected to each other through a network 101. Sheet processing apparatuses, such as a sheet-folding apparatus 107, a case-binding apparatus 108, a cutting apparatus 109, and a saddle-stitching/binding apparatus 110 are connected in the POD system 10000.

The printing system 1000 comprises a printing apparatus 100 and a sheet processing apparatus 200. In an embodiment, a Multi Function Peripheral (MFP), provided with a plurality of functions (such as a copying function and a printing function), is described as an example of the printing apparatus 100. However, the printing apparatus may be a single-function type provided with only a copying function or a printing function.

The server computer (PC) 103 controls the transmission and reception of data of the various apparatuses connected to the network 101. The client computer (PC) 104 transmits image data to the printing apparatus 100 and the PC 103 through the network 101. The sheet-folding apparatus 107 folds sheets that are printed by the printing apparatus 100. The case-binding apparatus 108 performs case binding on the sheets that are printed by the printing apparatus 100. The cutting apparatus 109 cuts a sheet bundle comprising the sheets that are printed by the printing apparatus 100. The saddle-stitching/binding apparatus 100 performs saddle-stitching/binding on the sheets that are printed by the printing apparatus 100.

When the sheet-folding apparatus 107, the case-binding apparatus 108, the cutting apparatus 109, or the saddle-stitching/binding apparatus 110 is used, a user takes out from the printing system 1000, the sheets that are printed by the printing apparatus 100. Then, the user sets the taken-out sheets to the apparatus that is used, so that the sheets are processed at the apparatus. The apparatuses of the POD system 10000 shown in FIG. 1 other than the saddle-stitching/binding apparatus are connected to the network 101, so that data communication between these apparatuses can be performed.

Here, the sheet processing apparatuses are defined by classifying them into three types, an in-line finisher, a near-line finisher, and an off-line finisher. The “in-line finisher” is defined as a sheet processing apparatus that satisfies both of the following Conditions 1 and 2. The “near-line finisher” is defined as a sheet processing apparatus that only satisfies the following Condition 2. The “off-line finisher” is defined as a sheet processing apparatus that satisfies neither of the following Conditions 1 and 2.

According to Condition 1, a sheet path (sheet conveying path) is physically connected to the printing apparatus 100 so that the sheets that are conveyed from the printing apparatus 100 can be directly received without any intervention by an operator.

According to Condition 2, for making it possible to perform data communication (requiring, for example, an operation instruction or confirmation of a state) with another apparatus, electrical connection is made with the other apparatus. More specifically, electrical connection is made so that data communication with the printing apparatus 100 can be performed, or electrical connection is made so that data communication can be performed with the apparatuses (PC 103, PC 104, etc.) through the network 101. If at least one of these electrical connections is realized, Condition 2 is satisfied.

That is, the sheet processing apparatus 200 corresponds to the “in-line finisher;” the sheet-folding apparatus 107, the case-binding apparatus 108, and the cutting apparatus 109 correspond to the “near-line finishers;” and the saddle-stitching/binding apparatus 110 corresponds to the “off-line finisher.”

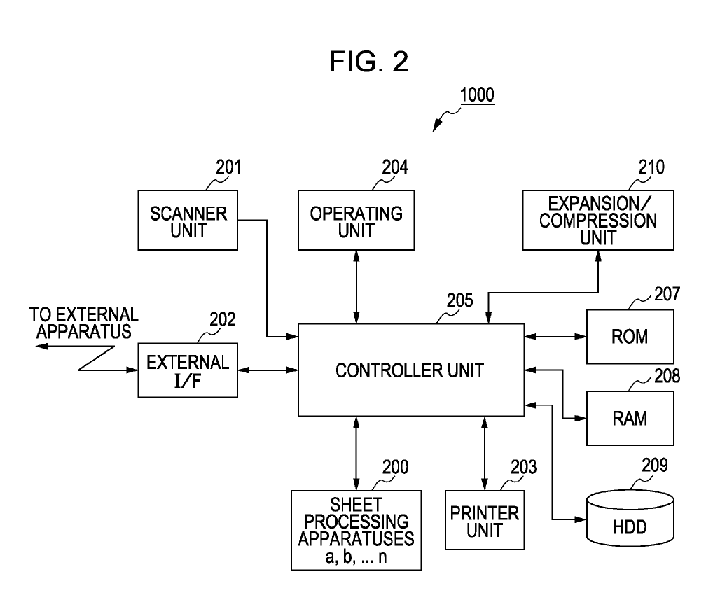

The structure of the printing system 1000 will now be described with reference to the system block diagram of FIG. 2.

Among the units which are shown in FIG. 2 and included in the printing system 1000, the units other than the sheet processing apparatus 200 are included in the printing apparatus 100. An arbitrary number of sheet processing apparatuses 200 can be connected to the printing apparatus 100.

The printing system 1000 is constructed so that sheet processing on the sheets that are printed by the printing apparatus 100 can be executed by the sheet processing apparatus 200 connected to the printing apparatus 100. However, the printing system 1000 may comprise only the printing apparatus 100, in which case the sheet processing apparatus 200 is not connected. The sheet processing apparatus 200 is constructed so as to allow communication with the printing apparatus 100. It receives an instruction from the printing apparatus 100, and can execute the sheet processing as described below.

In the printing apparatus 100, a scanner unit 201 reads an image on an original, converts the read image into image data, and transmits the image data to another unit. An external I/F 202 transmits data to and receives data from another apparatus connected to the network 101. A printer unit 203 forms an image on the basis of the input image data, and prints the image on a sheet. An operating unit 204 has a hardkey input section and a touch panel, and receives an instruction from a user therethrough. In addition, the operating unit 204 performs various display operations at the touch panel.

A controller unit 205 generally controls processing and operations of the various units of the printing system 1000. That is, the controller unit 205 also controls the operations of the printing apparatus 100 and the sheet processing apparatus 200 connected to the printing apparatus 100. ROM 207 stores various programs that are executed by the controller unit 205. For example, ROM 207 stores a program for executing various steps in flowcharts (described later) and a display control program for displaying various setting images (described later). In addition, ROM 207 records a program for causing the controller unit 205 to interpret Page-Description-Language (PDL) code data (received from, for example, the PC 103 or the PC 104), and to execute rendering to raster image data. Further, ROM 207 stores various programs such as boot sequence information and font information.

RAM 208 stores image data transmitted from the scanner unit 201 or the external IF 202, and various programs and setting information, stored in ROM 207. In addition, RAM 208 stores information regarding the sheet processing apparatus (for example, information regarding the number of sheet processing apparatuses (0 to n sheet processing apparatuses) connected to the printing apparatus 100 and the function of each sheet processing apparatus; and the order of connection of each sheet processing apparatus).

A hard disk drive (HDD) 209 includes, for example, a hard disk and a driving section that reads data from and writes data to the hard disk. The HDD 209 is a high-capacity storage device that stores image data input from the scanner unit 201 or the external IF 202 and compressed by an expansion/compression unit 210. The image data stored in the HDD 209 is printed as a result of the controller unit 205 giving an instruction to the printer unit 203 on the basis of an instruction from a user. In addition, the image data stored in the HDD 209 is transmitted to an external apparatus, such as the PC 103, by the controller unit 205 through the external IF 202 on the basis of an instruction from the user.

The expansion/compression unit 210 compresses/expands the image data, stored in the HDD 209 or RAM 208, by various compression methods, such as JBIG or JPEG.

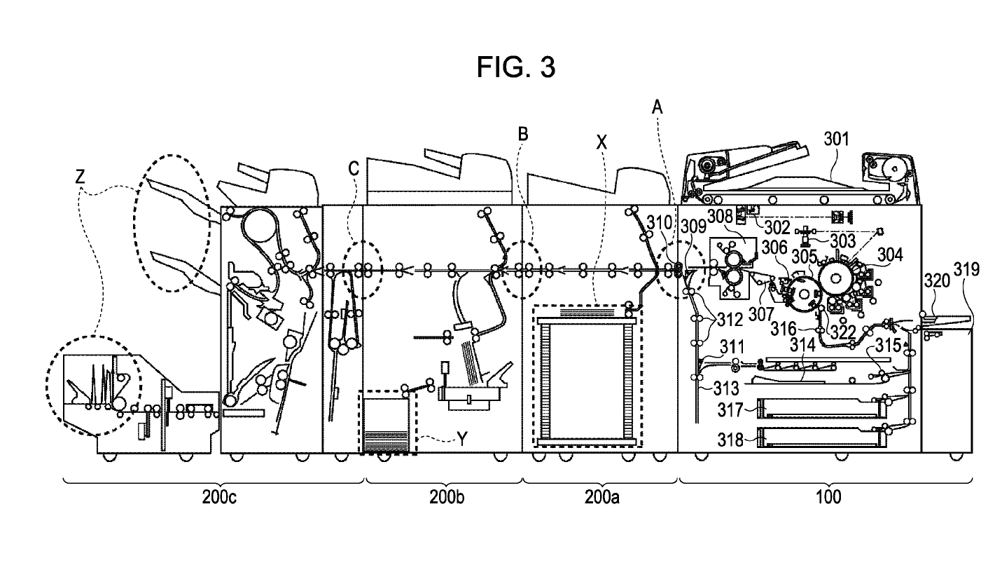

The structure of the printing system 1000 will now be described with reference to FIG. 3. FIG. 3 is a side sectional view of an exemplary internal structure of the printing system 1000. The printing system 1000 comprises the printing apparatus 100 and the sheet processing apparatus 200 connected to the printing apparatus 100.

First, the structure of the printing apparatus 100 will be described. An auto document feeder (ADF) 301 separates originals of an original bundle, which is set on a stacking surface of an original tray, in accordance with page order starting from the first page. Then, it conveys the originals to an original plate glass for scanning the originals by a scanner 302.

The scanner 302 reads an image of the original conveyed onto the original plate glass. Then, a CCD sensor converts the image of the original into image data. A light ray (such as laser light) modulated in accordance with the image data is caused to be incident upon a rotatable polygon mirror 303. Then, the incident light ray is converted into reflection scanning light through a reflecting mirror, and is used to irradiate a photosensitive drum 304. A latent image, formed on the photosensitive drum 304 by the laser light, is developed by toner, and toner image is transferred onto a sheet material that is adhered to a transfer drum 305. By successively executing the image forming process for yellow (Y) toner, magenta (M) toner, cyan (C) toner, and black (K) toner, a full color image is formed. After performing the image forming process four times, the sheet material on the transfer drum 305 on which the full color image is formed is separated by a separation pawl 306, to convey the separated sheet material to a fixing device 308 by a prior-to-fixing conveying unit 307. The fixing device 308 comprises a combination of a roller and a belt, and has a heat source (such as a halogen heater) built therein. By heat and pressure, the fixing device 308 melts and fixes the toner on the sheet material on which the toner image is transferred. A sheet-eject flapper 309 is swingable around a swing axis as a center, and defines the conveying direction of the sheet material. When the sheet-eject flapper 309 is swinging clockwise in the FIG. 3, the sheet material is conveyed in a straight line, and is ejected to the outside of the printing apparatus 100 through a sheet-eject roller 310. By the aforementioned sequence, the controller unit 205 controls the printing apparatus 100 so that it executes one-sided printing.

When images are to be formed on both sides of the sheet material, the sheet-eject flapper 309 is swung counterclockwise in FIG. 3, so that the path of the sheet material is changed downward to convey the sheet material to a conveyance unit for two-sided printing. The conveyance unit comprises a reversal flapper 311, reversal rollers 312, a reversal guide 313, and a double-sided tray 314. The reversal flapper 311 swings around a swing axis as a center, and defines the conveying direction of the sheet material. When a two-sided printing job is processed, the controller unit 205 controls the sheet having one side (a first surface) printed by the printer unit 203 so that it is conveyed to the reversal guide 313 through the reversal rollers 312 as a result of swinging the reversal flapper 311 counterclockwise in FIG. 3. Then, a rear end of the sheet material is temporarily stopped at the reversal roller 312 while it is nipped at the reversal rollers 312, and the reversal flapper 311 is subsequently swung clockwise in FIG. 3. In addition, the reversal rollers 312 are rotated in the reverse direction. By this, the controller unit 205 controls the sheet material so that, while the rear end and the front end of the sheet material are transposed as a result of switching back and conveying the sheet material, the sheet material is guided to the double-sided tray 314. The sheet material is temporarily placed on the double-sided tray 314. Then, it is conveyed to a registration roller 316 by a re-feeding roller 315. At this time, the sheet material is conveyed so that the surface (second surface) of the sheet material opposite to the first surface previously subjected to the transfer step faces the photosensitive drum. Then, the same process as that described above is performed to form an image on the second surface of the sheet. As a result, the images are formed on both sides of the sheet material, and are fixed by a fixing step, after which the sheet material is ejected to the outside of the printing apparatus 100 from the interior of the main body of the printing apparatus 100 through the sheet-eject roller 310. By the aforementioned sequence, the controller unit 205 controls the printing apparatus 100 so that it executes two-sided printing.

The printing apparatus 100 has sheet-feed units that accommodate sheets required for the printing. The sheet-feed units include, for example, sheet-feed cassettes 317 and 318 (that can each accommodate, for example, 500 sheets), a sheet-feed deck (that can accommodate, for example, 5000 sheets), and a manual sheet-feed tray 320. The sheet-feed cassettes 317 and 318, and the paper deck 319 can be used to set various sheets having different sizes and formed of different materials according to sheet-feed units. The manual sheet-feed tray 320 can be used to set various sheets including special sheets, such as OHP sheets. The sheet-feed cassettes 317 and 318, the paper deck 319, and the manual sheet-feed tray 320 are each provided with sheet-feed rollers that continuously feed the sheets one sheet at a time.

The sheet processing apparatus 200 will now be described. As long as sheets can be conveyed through the sheet conveying path from an upstream apparatus to a downstream apparatus, any number of sheet processing apparatuses 200 (five apparatuses at most) of any type may be connected. For example, a high-capacity stacker 200a, a sizing/binding apparatus 200b, and a saddle-stitching/binding apparatus 200c are connected to each other in that order from the side closest to the printing apparatus 100, and can be selectively used in the printing system 1000. Each of the sheet processing apparatuses comprises a sheet eject unit, so that a user can take out a processed sheet from the sheet eject unit of each sheet processing apparatus.

Through the operating unit 204, the controller unit 205 receives, in addition to a print execution request, a request for executing sheet processing of a type desired by the user from among sheet processing types that can be executed by the sheet processing apparatuses 200 connected to the printing apparatus 100. Then, in accordance with the reception of the print execution request of a job, to be processed, from the user through the operating unit 204, the controller unit 205 causes the printer unit 203 to execute printing required for the job. Thereafter, through the sheet conveying path, the controller unit 205 conveys a sheet for the job on which printing is performed to the sheet processing apparatus where the sheet processing that is desired by the user can be performed. Then, the sheet processing apparatus performs the sheet processing.

For example, when the printing system 1000 has the system structure shown in FIG. 3, if the job to be processed and for which a request is made by the user to execute printing is a job in which the high-capacity stacker 200a is instructed to stack a large number of sheets, this job is called a stacker job.

When this stacker job is processed by the system structure shown in FIG. 3, the controller unit 205 causes the sheet for this job in which printing has been performed at the printing apparatus 100 to pass point A shown in FIG. 3, and to be conveyed to the interior of the high-capacity stacker. Then, the controller unit 205 causes the high-capacity stacker 200a to execute the job of stacking the sheets. The controller unit 205 holds a printed material for this job, in which the high-capacity stacker 200a has performed the stacking, at a sheet-eject destination X in the high-capacity stacker 200a, without conveying it to another apparatus (such as a following apparatus).

The user can directly take out from the sheet-eject destination X, the printed material for the stacker job that is held at the eject destination X shown in FIG. 3. As a result, it is not necessary to perform the aforementioned user operation and series of apparatus operations, including conveying the sheet to the sheet-eject destination Z at the lowermost stream side in the sheet conveying direction shown in FIG. 3, and taking out the printed material for the stacker job from the sheet-eject destination Z.

If the job to be processed and for which a request is made by the user to execute printing by the system structure shown in FIG. 3 is a job in which the sizing/binding apparatus 200b is instructed to perform sheet processing (for example, either one of the sizing/binding operations, case binding or a heaven sizing/binding operation), this job is called a sizing/binding job.

When this sizing/binding job is processed by the system structure shown in FIG. 3, the controller unit 205 causes the sheet printed at the printing apparatus 100 to be conveyed to the interior of the sizing/binding apparatus 200b through the point A and point B shown in FIG. 3. Then, the controller unit 205 causes the sizing/binding apparatus 200b to performing the sizing/binding operation of the job. Thereafter, the controller unit 205 holds a printed material for this job, in which the sizing/binding apparatus 200b has performed the sizing/binding operation, at a sheet-eject destination Y in the sizing/binding apparatus 200b, without conveying it to another apparatus (such as a following apparatus).

Further, the job to be processed and for which a request is made by the user to execute printing by the system structure shown in FIG. 3 may be a job in which the saddle-stitching/binding apparatus 200c is instructed to perform sheet processing. The sheet processing by the saddle-stitching/binding apparatus 200c includes, for example, saddle-stitching/binding, punching, cutting, shift sheet ejection, and folding. This job is called a saddle-stitching/binding job.

When the saddle-stitching/binding job is processed by the system structure shown in FIG. 3, the controller unit 205 causes the sheet for this job printed at the printing apparatus 100 to be conveyed to the saddle-stitching/binding apparatus 200c through the points A and point B and point C shown in FIG. 3. Then, the controller unit 205 causes the saddle-stitching/binding apparatus 200c to perform the sheet processing for the job. Thereafter, the controller unit 205 holds a printed material for this saddle-stitching/binding job, in which the saddle-stitching/binding apparatus 200c has performed the sheet processing, at sheet-eject destinations Z at the saddle-stitching/binding apparatus 200c.

There are a plurality of choices for the sheet-eject destinations Z. This allows the saddle-stitching/binding apparatus to execute a plurality of sheet processing types, and to be used when providing different sheet eject destinations for the respective sheet processing types.

As shown in FIGS. 1 to 3, in the printing system 1000 according to the embodiment, a plurality of sheet processing apparatuses can be connected to the printing apparatus 100. The sheet processing apparatuses can be connected to the printing apparatus 100 in any combination. In addition, the order of connection of the sheet processing apparatuses may be freely changed within a range in which sheet conveying paths of the sheet processing apparatuses can be connected to each other. Further, there are a plurality of types of sheet processing apparatuses that can be connected to the printing apparatus 100.

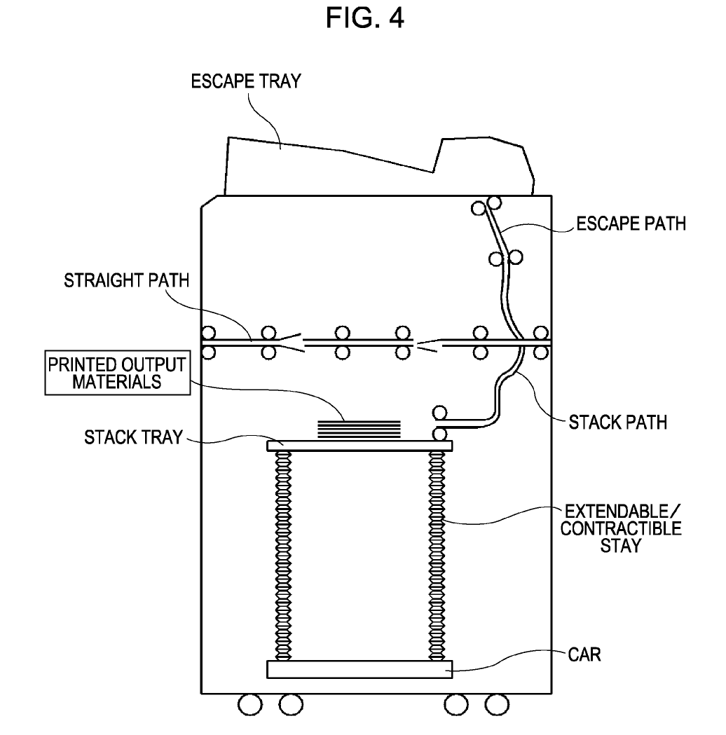

The internal structures of sheet processing apparatuses that can be connected to the printing apparatus 100 will now be described according to types with reference to FIGS. 4 to 6.

First, the internal structure of a high-capacity stacker will be described using the sectional view of FIG. 4. The high-capacity stacker selectively conveys a sheet conveyed from an upstream apparatus through any one of the three conveying paths (an escape path, a stack path, and a straight path).

The stack path in the high-capacity stacker is a sheet conveying path for conveying the sheet to a stack tray. The stack tray shown in FIG. 4 is a stacking unit placed on, for example, an extendable/contractible stay. A removable car is provided below the extendable/contractible stay. The car allows an operator to transport sheets stacked on the stack tray.

If a user receives through the operating unit 204 a request for executing a job that is set so that the high-capacity stacker performs a sheet stacking operation, the controller unit 205 conveys a sheet printed at the printing apparatus 100 through the stack path of the high-capacity stacker, and ejects the printed sheet to the stack tray through the stack path.

The straight path of the high-capacity stacker shown in FIG. 4 is a sheet conveying path for conveying to a following apparatus a sheet for a job in which a sheet stacking operation using the stack tray of the high-capacity stacker is not required.

The escape path is a sheet conveying path for ejecting a sheet to the escape tray (also called a sample tray), and is used when output is carried out without stacking. For example, when confirmation of an output (proof printing) is to be carried out, it is possible to convey a printed material to the escape path and take out the printed material from the escape tray.

A plurality of sheet detection sensors, required for detecting a sheet conveyance state and any jamming, are provided at the sheet conveying paths in the high-capacity stacker.

The high-capacity stacker is provided with a CPU (not shown), and sends sheet detection information from each sensor to the controller unit 205 through signal wires for performing data communication. On the basis of the information from the high-capacity stacker, the controller unit 205 is informed about the sheet conveyance state and jamming in the high-capacity stacker. When another sheet processing apparatus is connected between the high-capacity stacker and the printing apparatus 100, a CPU (not shown) of this other sheet processing apparatus sends the sensor information of the high-capacity stacker to the controller unit 205.

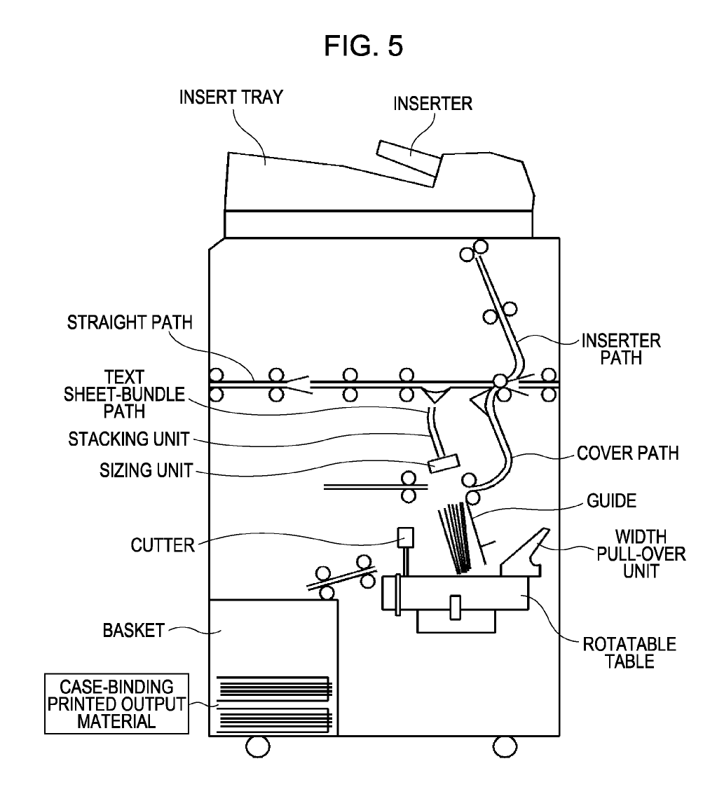

Next, the internal structure of a sizing/binding apparatus will be described with reference to the sectional view of FIG. 5. The sizing/binding apparatus selectively conveys a sheet conveyed from an upstream apparatus through any one of the three conveying paths (a cover path, a text sheet-bundle path, and a straight path).

The sizing/binding apparatus also has an inserter path. The inserter path is a sheet conveying path for conveying a sheet placed on an insert tray to the cover path.

The straight path of the sizing/binding apparatus shown in FIG. 5 is a sheet conveying path for conveying to a following apparatus a sheet for a job in which a sizing/binding operation using the sizing/binding apparatus is not required.

The text sheet-bundle path and the cover path of the sizing/binding apparatus shown in FIG. 5 are sheet conveying paths for conveying sheets required to form case-binding printed materials.

For example, when a case-binding printed material is to be formed with the sizing/binding apparatus, the controller unit 205 causes the printer unit 203 to print text image data to be printed on a text sheet of the case-binding printed material. When case-binding printed materials for one book are to be formed, a sheet bundle for one book of text sheets are covered by one cover. In the case binding, this sheet bundle is called the “text sheet bundle.”

The controller unit 205 performs a controlling operation so that sheets that are printed at the printing apparatus 100 and that are used for the text sheet bundle are conveyed to the text sheet-bundle path shown in FIG. 5. When case binding is to be performed, the controller unit 205 causes the text sheet bundle printed at the printing apparatus 100 to be covered by a cover sheet conveyed through the cover path.

For example, the sheets that are conveyed from an upstream apparatus and that become a text sheet bundle are successively stacked upon a stacking unit through the text sheet-bundle path shown in FIG. 5. When the sheets having text data printed thereon are stacked upon the stacking unit so that the number of sheets is equal to that of one book, the controller unit 205 conveys one cover sheet, required for this job, through the cover path. The controller unit 205 controls a sizing unit shown in FIG. 5 so that sizing is performed on a spine of the sheet bundle for one set corresponding to the text sheet bundle. Then, the controller unit 205 performs a controlling operation so that the sizing unit joins the central portion of the cover and the spine of the text sheet bundle. When the text sheet bundle is to be joined to the cover, the text sheet bundle is conveyed so as to be pushed in a downward direction of the apparatus. This causes the cover to be folded so that one cover covers the text sheet bundle. Thereafter, the one set of sheet bundle is stacked upon a rotatable table shown in FIG. 5 along a guide.

After setting the one set of sheet bundle upon the rotatable table shown in FIG. 5, the controller unit 205 causes a cutter shown in FIG. 5 to cut the sheet bundle. Here, the cutter can perform three-sided cutting in which three edges (other than an edge corresponding to the spine) of the one set of sheet bundle are cut. Then, after the three-sided cutting, the resulting sheet bundle is pushed out in the direction of a basket using a width pull-over unit, and is accommodated in the basket shown in FIG. 5.

When performing a case-binding job, a cover used for covering the text sheet bundle is provided by using a sheet on which print data is previously printed as mentioned above. When the cover is provided in this way, the following may also be performed. That is, the printer unit 203 prints cover data on the cover in the case-binding job. The controller unit 205 controls the printing system 1000 so that the printing of the cover data on the sheet that becomes the cover is performed in response to the printing of the text sheet bundle. In addition, the controller unit 205 performs a controlling operation so that the sizing/binding apparatus executes the case-binding operation in response to the printing of the cover and the printing of the text sheet bundle and using these print results. Accordingly, the printing system 1000 according to the embodiment is constructed so that these three types of operations (the printing of the text sheet bundle, the printing of the cover, and the case binding) are successively executed in one case-binding job.

The case binding that is described as one sizing/binding operation in the embodiment has the following features.

For example, the number of sheets that can be processed as one sheet bundle in the case binding is overwhelmingly greater than the number of sheets that can be processed as one sheet bundle in other types of sheet processing operations. For example, the case binding allows up to 200 sheets to be processed as one text sheet bundle. In contrast, for example, a stapling operation allows only up to 20 print sheets to be processed as one sheet bundle, and a saddle-stitching/binding operation only allows up to 15 print sheets to be processed as one sheet bundle. Therefore, the number of print sheets that can be processed as one sheet bundle is much greater in the sizing/binding operation than in the other types of sheet processing operations.

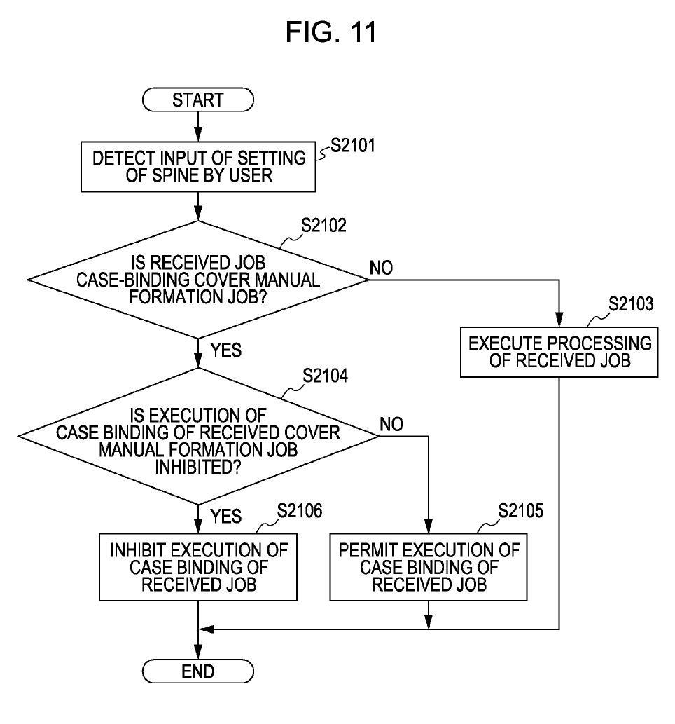

In addition, compared to the other types of sheet processing operations, the number of processing steps and the number of structural features that need to be prepared are large. For example, the processing time required to complete the processing tends to be longer in the case binding than in sheet processing operations that are frequently used in an office environment, such as stapling and saddle-stitching/binding. In the embodiment, while considering such points, the printing system 1000 is constructed so that it has the following structural features (for example, the structural features illustrated from FIG. 11 on).

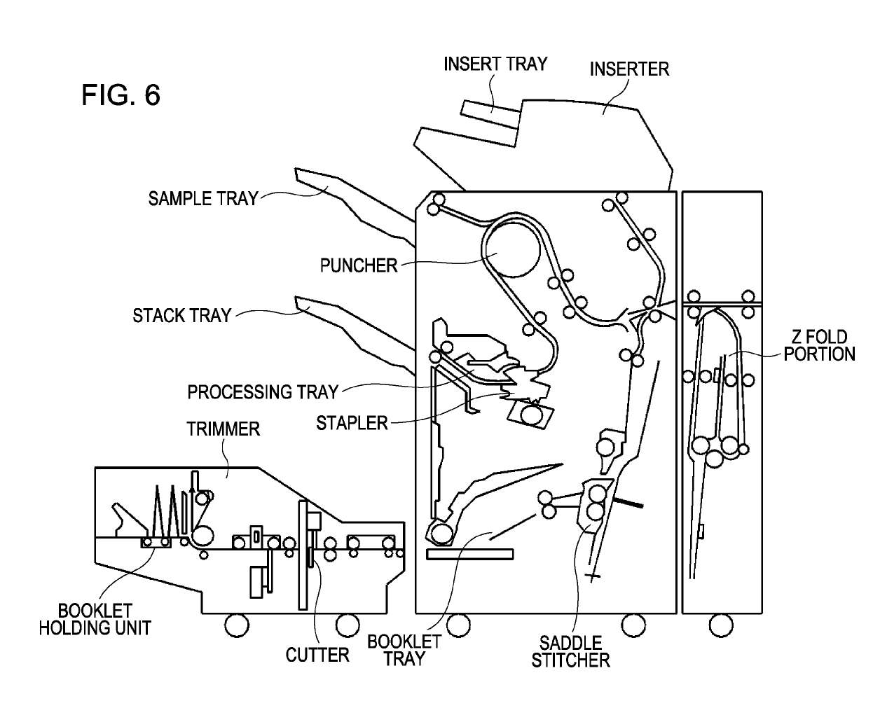

The internal structure of a saddle-stitching/binding apparatus will now be described with reference to the sectional view of FIG. 6. The saddle-stitching/binding apparatus comprises various units that selectively execute, for example, the following operations on a sheet from the printing apparatus 100. The operations include stapling, cutting, punching, folding, shift sheet ejection, and saddle-stitch/binding. The saddle-stitching/binding apparatus is not provided with a straight path that conveys a sheet to a following apparatus. Therefore, when a plurality of sheet processing apparatuses are connected to the printing apparatus 100, as shown in FIG. 3, the saddle-stitching/binding apparatus is connected at the rear.

As shown in FIG. 6, a sample tray and a stack tray are provided outside the saddle-stitching/binding apparatus, and a booklet tray is provided in the saddle-stitching/binding apparatus.

When the saddle-stitching/binding apparatus receives an instruction to perform stapling, the controller unit 205 causes sheets printed at the printing apparatus 1000 to be successively stacked upon a processing tray in the apparatus. When the number of sheets stacked upon the processing tray is equal to that corresponding to one sheet bundle, the controller unit 205 causes a stapler to perform the stapling. Then, the controller unit 205 causes the stapled sheet bundle to be ejected onto a stack tray shown in FIG. 6 from the processing tray.

When the controller unit 205 executes a job in which the saddle-stitching/binding apparatus is instructed to perform a Z folding operation, the sheets printed at the printing apparatus 100 are folded into the shape of the letter Z at a Z fold portion. The controller unit 205 performs a controlling operation so that the folded sheets pass through the interior of the saddle-stitching/binding apparatus and are ejected onto sheet-eject trays, such as the stack tray and the sample tray.

When the controller unit 205 receives an instruction to cause the saddle-stitching/binding apparatus to perform a punching setting operation, a puncher punches the sheets printed at the printing apparatus 100. Then, the controller unit 205 performs a controlling operation so that the punched sheets pass through the interior of the saddle-stitching/binding apparatus and are ejected onto the sheet-eject trays, such as the stack tray and the sample tray.

When the controller unit 205 executes a job in which the saddle-stitching/binding apparatus is instructed to perform saddle-stitching/binding, a saddle stitcher stitches two locations of the central portion of a sheet bundle including a plurality of sheets of one set. Then, the controller unit 205 causes the central portion of the sheet bundle to be nipped by rollers, so that the sheet bundle is folded in two with reference to the central portion of the sheets. This makes it possible to form a booklet, such as a pamphlet. The sheet bundle that has been subjected to the saddle-stitching/binding operation at the saddle stitcher is conveyed to the booklet tray.

When the controller unit 205 receives an instruction to perform a cutting operation for the job in which the saddle-stitching/binding apparatus is instructed to perform the saddle-stitching/binding operation, the controller unit 205 conveys the sheet bundle that has been saddle-stitched and bound to a trimmer from the booklet tray. Then, the controller unit 205 causes a cutter to cut the sheet bundle conveyed to the trimmer, so that the resulting sheet bundle is held at a booklet holding unit. Even the saddle-stitching/binding apparatus is capable of executing three-sided cutting of the sheet bundle that is saddle-stitched and bound.

When the saddle-stitching/binding apparatus is not provided with a trimmer, the sheet bundle bound at the saddle stitcher can be take out from the booklet tray.

The saddle-stitching/binding apparatus is capable of attaching a sheet that is set on the insert tray shown in FIG. 6 (for example, a previously printed cover sheet) to a sheet printed at and conveyed from the printing apparatus 100.

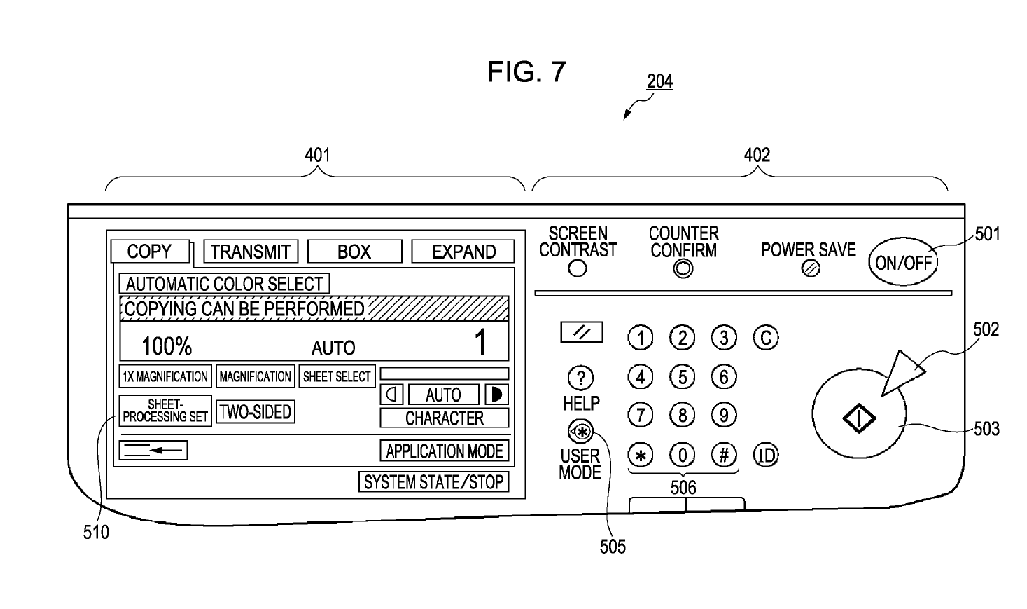

Next, the structure of the operating unit 204 will be described with reference to FIG. 7. The operating unit 204 comprises a touch panel and a key inputting unit 402. The touch panel 401 comprises a liquid crystal display (LCD) and a transparent electrode adhered to the top portion of the LCD. The touch panel 401 displays various setting user interfaces for receiving instructions from a user. The touch panel 401 has the function of displaying various setting user interfaces and an instruction-input function of receiving an instruction from the user. The key inputting unit 402 includes a power key 501, a start key 503, a stop key 502, a user mode key 505, and a numerical keypad 506. The start key 503 is used when causing the printing apparatus 100 to start a copy job or a transmission job. The numerical keypad 506 is used when setting an input of numbers, such as the number of printed sheets.

The controller unit 205 controls the printing system 1000 so that various processing operations are performed on the basis of a user instruction received through various setting user interfaces displayed on the touch panel 401 or a user instruction received through the key inputting unit 402.

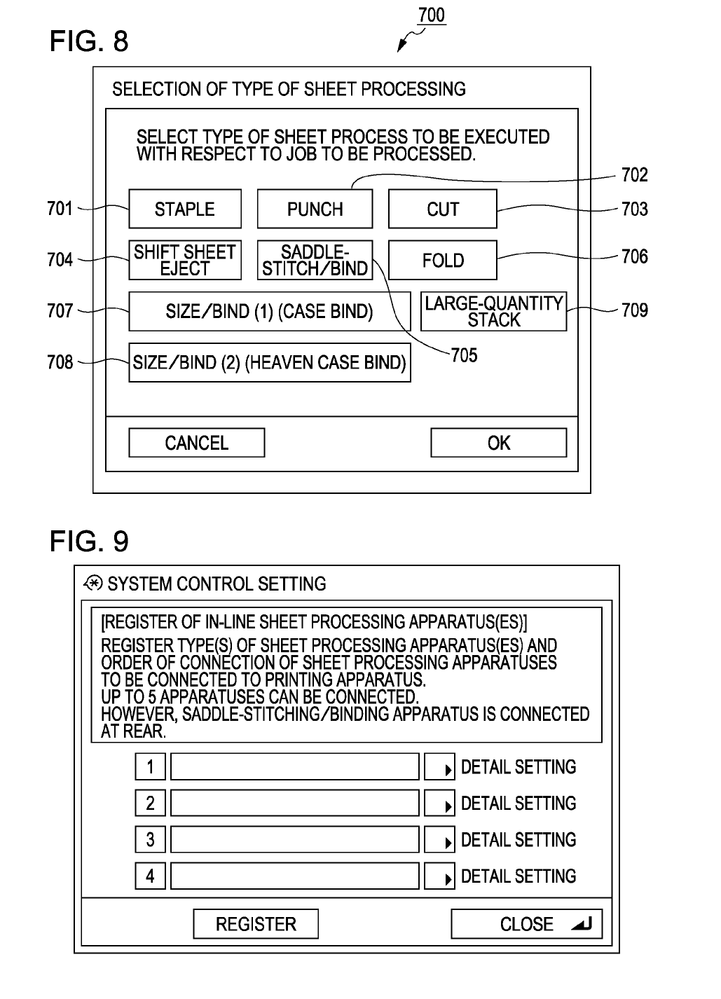

FIG. 8 shows a setting user interface for allowing a user to select various sheet processing operations to be executed on a sheet printed by the printing apparatus 100. When the user presses a sheet-processing setting key 510 shown in FIG. 7 and displayed on a screen of the touch panel 401, the controller unit 205 causes a display shown in FIG. 8 to be provided on the touch panel 401. This display is a setting user interface that allows the user to select the types of sheet processing operations that can be executed with the sheet processing apparatuses 200 existing in the printing system 1000. For example, the user can select staple 701, punch 702, cut 703, shift sheet eject 704, saddle-stitch/bind 705, fold 706, size/bind (case bind) 707, size/bind (heaven size/bind) 708, and large-quantity stacking 709. The controller unit 205 receives the setting of a sheet processing operation to be executed in a job to be processed, from the user through this setting user interface. Then, the controller unit 205 causes the sheet processing apparatus 200 to execute the sheet processing operation in accordance with the setting.

The display shown in FIG. 9 corresponds to a setting user interface that allows the user to register information specifying, for example, what types of and how many sheet processing apparatuses are to be connected in what order when the sheet processing apparatuses 200 are to be connected to the printing apparatus 100. When the user mode key 505 is pressed, the controller unit 205 causes the display shown in FIG. 9 to be provided on the touch panel 401.

For example, when the printing system 10000 has the system structure shown in FIG. 3, register information indicting that three sheet processing apparatuses (the high-capacity stacker, the sizing/binding apparatus, and the saddle-stitching/binding apparatus) are to be successively connected to the printing apparatus 100 starting from the high-capacity stacker is set at the setting user interface shown in FIG. 9 by the user. The controller unit 205 causes RAM 208 to retain, as system structure information, information regarding the sheet processing apparatuses 200 and set by the user through the setting user interface shown in FIG. 9, and reads out the information and refers to it as appropriate. By this, the controller unit 205 confirms, for example, what types of and how many sheet processing apparatuses are connected in what order to the printing apparatus 100.

In the setting user interface shown in FIG. 9, when the user sets the saddle-stitching/binding apparatus (not having a straight path) between the plurality of sheet processing apparatuses, the controller unit 205 causes the touch panel 401 to display an error indicating that the setting is invalid. As shown in FIG. 9, the controller unit 205 causes the touch panel 401 to display guidance information notifying the user to connect the saddle-stitching/binding apparatus at the rear in order not to perform the aforementioned setting.

Although, in the embodiment, the operating unit 204 of the printing apparatus 100 is described as an exemplary user interface unit applied to the printing system 1000, the present invention is not limited thereto. For example, processing based on the instruction from a user interface unit of an external apparatus, such as the PC 103 or the PC 104, may be executed by the printing system 1000.

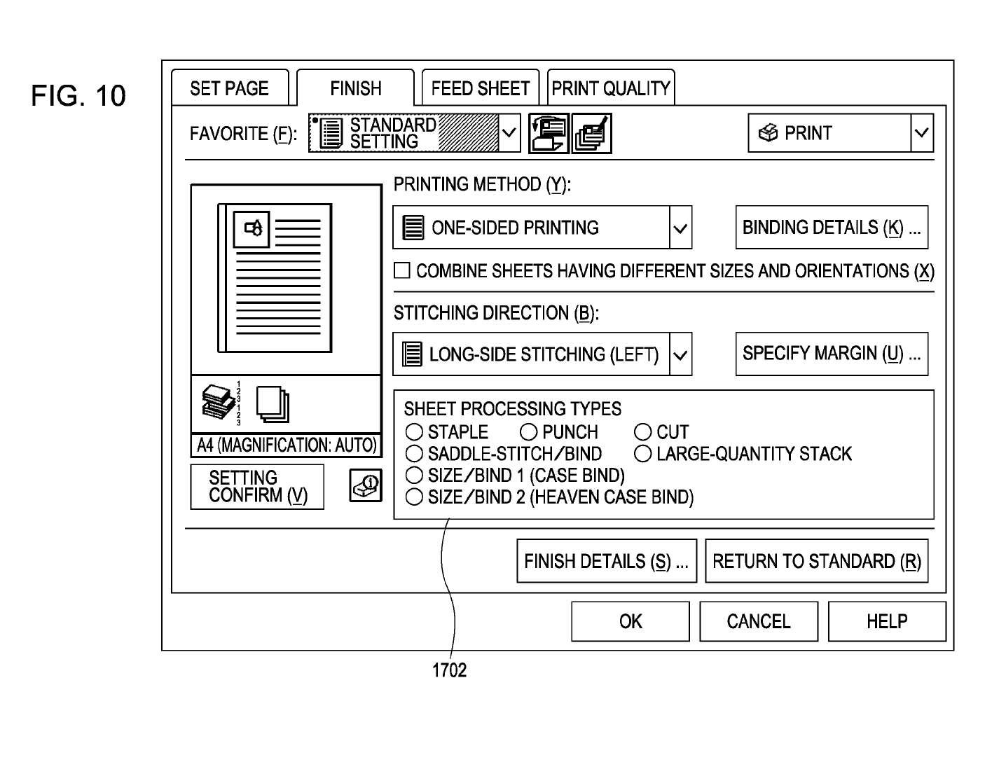

Accordingly, when remote controlling the printing apparatus 1000 from an external apparatus, a setting user interface regarding the printing system 1000, such as that shown in FIG. 10, is displayed on a display unit of the external apparatus. The PC 104 will be used as an example in the following description. FIG. 10 shows the setting user interface that is displayed on a display unit of the PC 104.

When a CPU of the PC 104 receives a print request from a user, the display displays the setting user interface, such as that shown in FIG. 10, to receive from the user of the PC 104 printing conditions through the setting user interface. For example, through a setting column 1702, the CPU of the PC 104 receives from the user the type of sheet processing to be executed by the sheet processing apparatus 200 for a print job whose execution is requested from the PC 104. Then, when the request for executing printing is received as a result of an OK key shown in FIG. 10 being pressed, the CPU of the PC 104 associates image data to be printed and the printing condition received through the setting user interface to provide one job, so that controlling is performed to transmit this job to the printing system 1000 through the network 101.

When the controller unit 205 of the printing system 1000 receives the print execution request of this job through the external I/F 202, the controller unit 205 controls the printing system 1000 so that the job from the PC 104 is processed on the basis of the printing condition transmitted from the PC 104.

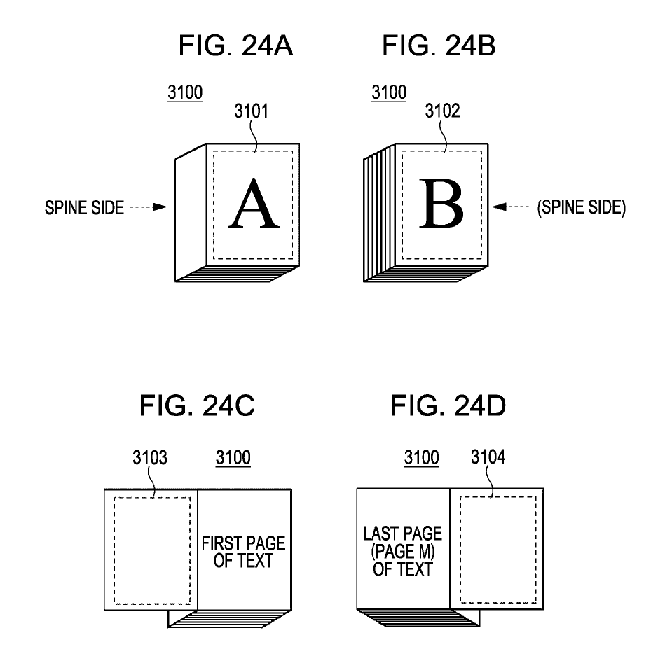

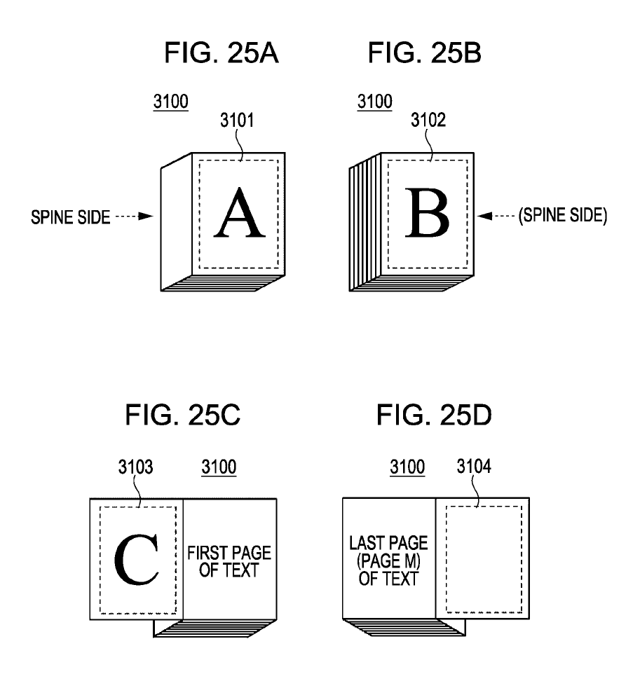

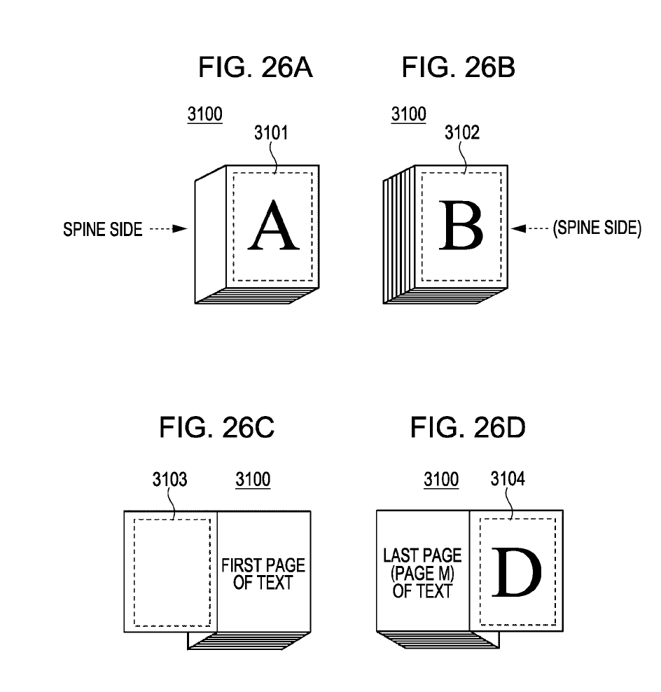

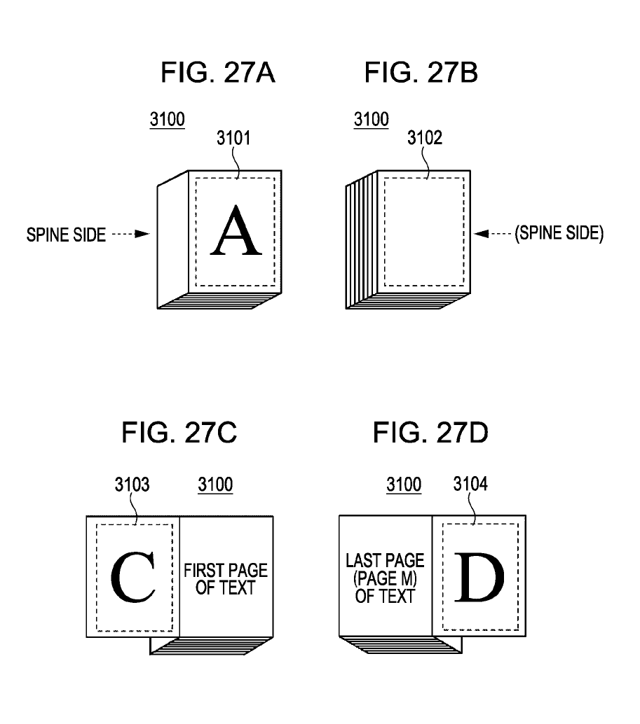

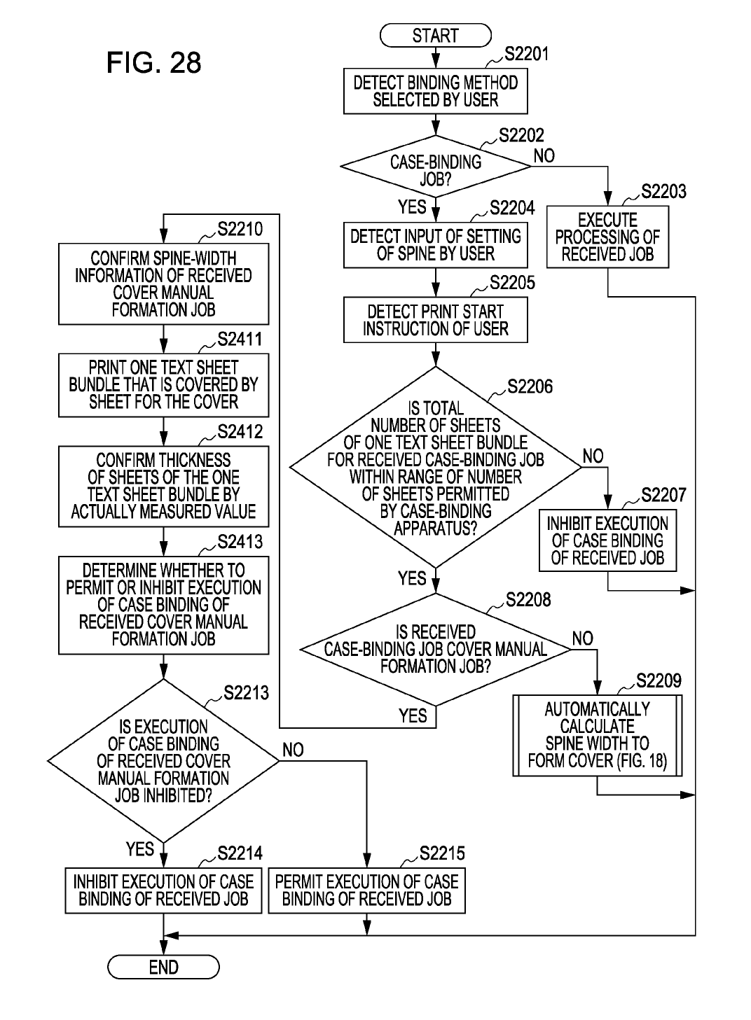

Features of executing a case binding job in the printing system 1000, according to an embodiment, will now be described in detail with reference to FIGS. 11 to 27.

FIG. 11 shows an exemplary flowchart conceptually illustrating a controlling process of a case-binding job (also called a perfect-binding job). S2101 to S106 denote the steps of the controlling process.

First, in Step S2101, the controller unit 205 of the printing system 1000 detects an input of a setting of a spine width (size about a spine) of a cover for a print job. The spine width is set by an operator through the user interface unit (operating unit 204).

Next, in Step S2101, the controller unit 205 confirms whether the binding method of the print job is case binding. In addition, it confirms whether the operator has manually set an interval between a back-cover image and a front-cover image at a case-binding cover (also called “perfect-bound cover”) sheet. Accordingly, a determination is made as to whether or not an automatic mode is set as a mode for when cover print data is printed on the sheet used as a cover in the case-binding job.

When, in Step S2101, the controller unit 205 confirms that the binding method of the print job is not case binding, or that the operator does not manually set the interval between the front-cover image and the back-cover image at the perfect-bound-cover sheet, the process proceeds to Step S2103.

In Step S2103, the controller unit 205 performs a controlling operation so as to execute the job, so that the controlling process of the flowchart is ended.

In contrast, when the controller unit 205 confirms that the binding method of the job is case binding, and that the operator manually sets the interval between the front-cover image and the back-cover image at the perfect-bound-cover sheet, the process proceeds to Step S2104.

In Step S2104, the controller unit 205 determines whether or not to inhibit the case-binding operation of the job.

When, in Step S2104, the controller unit 205 does not determine to inhibit the case-binding operation of the job, the controller unit 205 permits the case-binding operation of the job in Step S2105, so that the controlling process of the flowchart is ended.

In contrast, when, in Step S2104, the controller unit 205 determines to inhibit the case-binding operation of the job, the process proceeds to Step S2106.

In Step S2106, the controller unit 205 inhibits the case-binding operation of the job, so that the controlling process of the flowchart is ended.

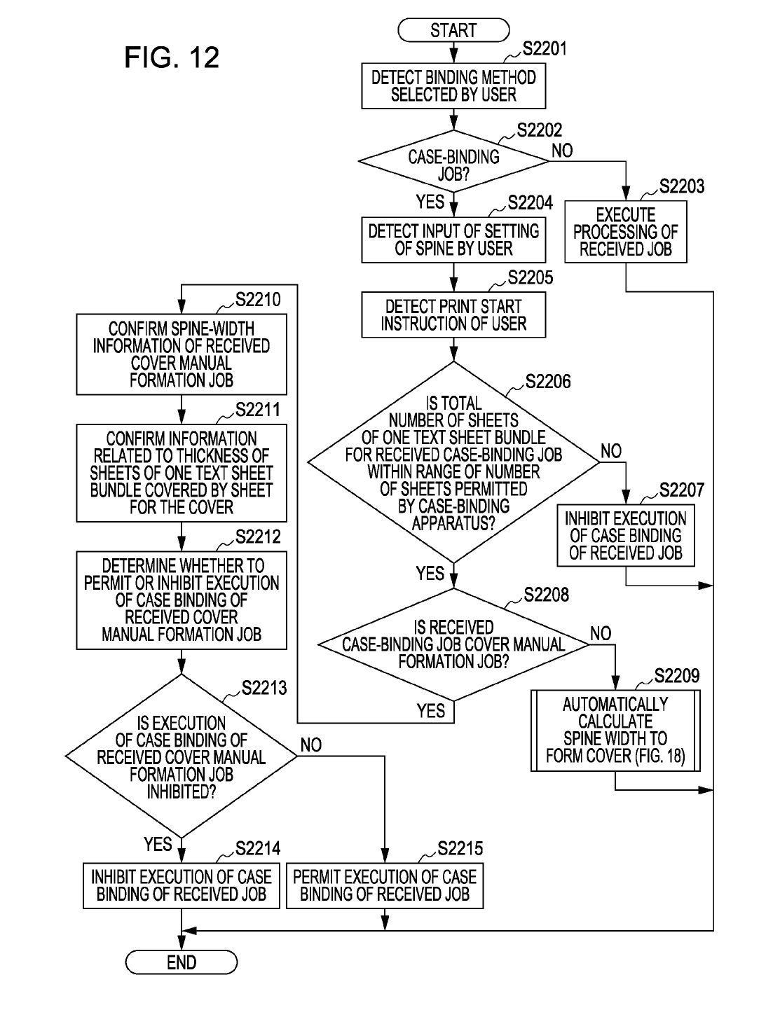

The details the controlling process in an embodiment of the present invention will now be described with reference to FIGS. 12 to 27.

The flowchart of FIG. 12 is a detailed version of the flowchart of FIG. 11.

Here, FIG. 12 shows a flowchart of an exemplary first controlling process procedure. The steps of the flowchart are performed as a result of the controller unit 205 of the printing system 1000 shown in FIG. 2 reading out and executing a program for executing the controlling process flowchart of FIG. 12. The program is previously stored in a memory (storage medium such as the HDD 208) as a computer program that can be read by a computer. In FIG. 12, S2201 to S2215 denote the steps of the controlling process.

As described below, in an embodiment, processing operations, determinations, and controlling operations are performed in accordance with various instructions from a user from the user interface unit applied when performing operations on the printing system 1000. Although the operating unit 204 of the printing apparatus 100 is used as the user interface unit, other apparatuses may be used. For example, an external remote user interface, which is distinguished from the printing apparatus 100, may also be used. Examples thereof include a pointing device and a monitor of an information processing apparatus, such as the PC 103 and the PC 104.

Although, in the following description, the controller unit 205 is used to perform controlling operations related to the user interface unit, the present invention is not limited thereto.

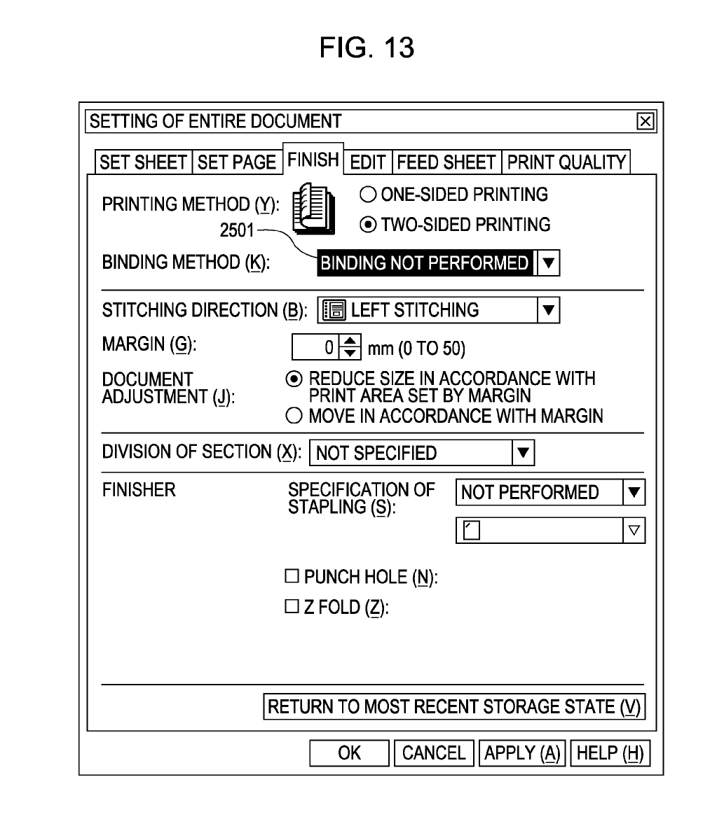

For example, the printing system 1000 according to the embodiment is constructed so that user interfaces related to case-binding jobs, shown in FIGS. 13, 14, 15, and 21, can be displayed on a remote user interface unit of an external apparatus, such as the PC 103 or the PC 104, which differs from the printing apparatus 100. The printing system 1000 is constructed so that processing operations, determinations, and controlling operations in accordance with instructions from the user interface unit can be performed on the printing system 1000. In this case, the determinations and the controlling operations are performed by a CPU of the external apparatus. The printing system 1000 according to the embodiment is constructed, not only so that the controller unit 205 operates as a controlling device, but also so that a controller unit of the external apparatus that remotely controls the printing system 1000 operates as a controlling device. In this case, the operations of the various flowchart steps described below are performed by the controller unit (CPU) of the external apparatus. The features of the embodiment will be described below using, as a typical example, a structure in which the controller unit 205 operates as a controlling device.

First, in the embodiment, when setting printing for a job, the controller unit 205 of the printing system 1000 causes the operating unit 204 to display a printing setting user interface illustrated in FIG. 13. When an operator selects the binding method using a binding method selection column 2501 of the printing setting user interface, the controller unit 205 starts the operations of the flowchart.

In Step S2201, the controller unit 205 detects the selected binding method of the print job through the operating unit 204.

Next, in Step S2202, the controller unit 205 determines whether or not the binding method selected by the operator is case binding (that is, whether the print job is a case-binding job).

When, in Step S2202, the controller unit 205 determines that the binding method selected by the operator is not case binding, the process proceeds to Step S2203.

In Step S2203, when the controller unit 205 is instructed to start the job through the operating unit 204, the controller unit 205 performs a controlling operation so as to receive and execute the job. Then, when the Step S2203 is completed, the controller unit 205 ends the controlling process of the flowchart.

When, in Step S2202, the controller unit 205 determines that the binding method selected by the operator is case binding (that is, the print job is a case-binding job), the controller unit 205 causes the process to proceed to Step S2204.

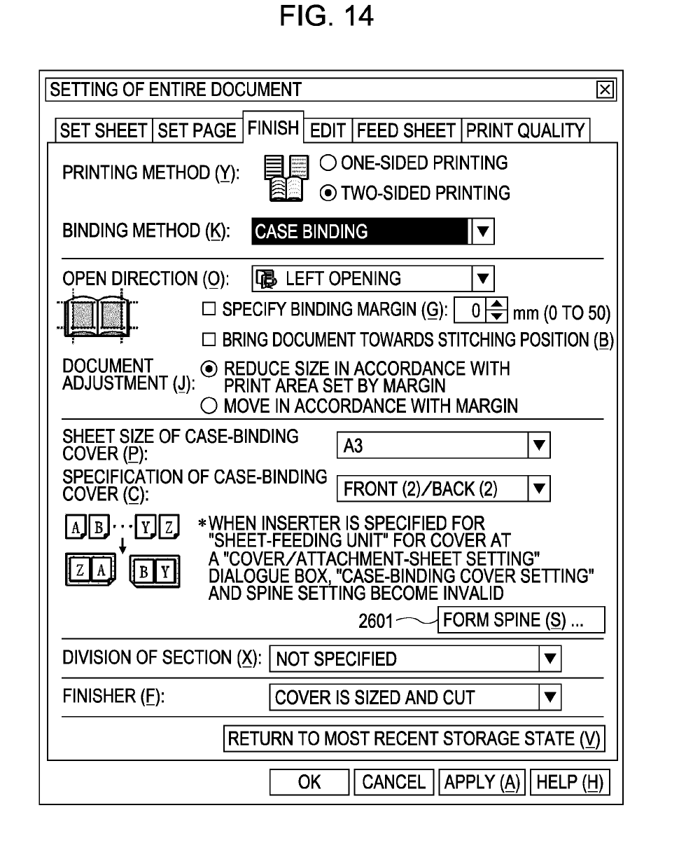

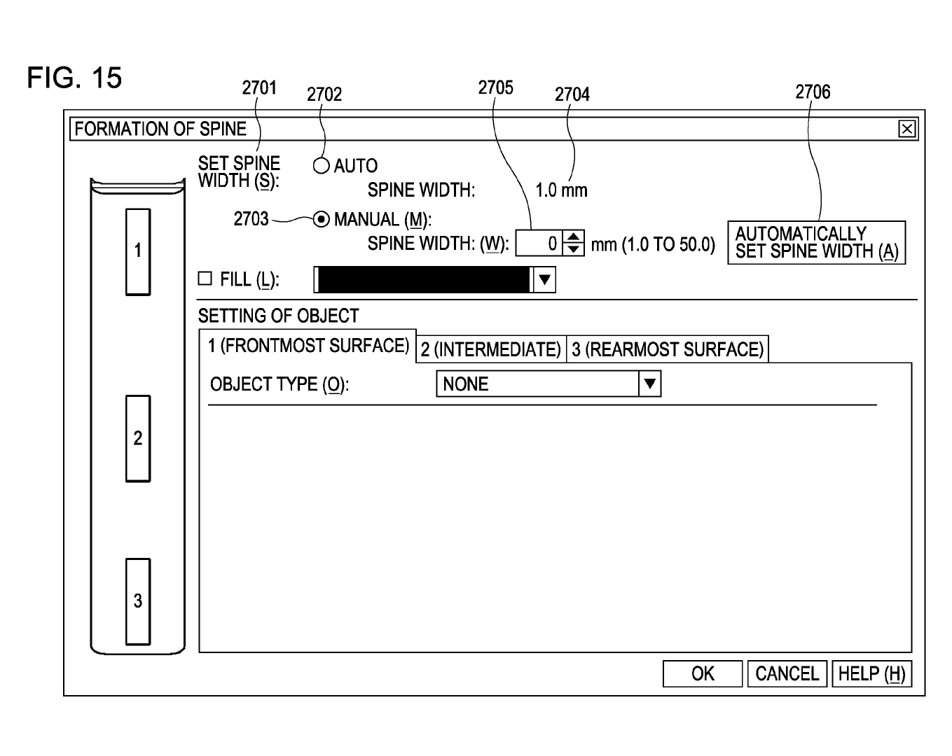

In Step S2204, the controller unit 205 detects the setting of a spine set by the operator for the job through the operating unit 204. In the embodiment, when “case-binding” is selected in a binding method selection column 2501 (FIG. 13), the controller unit 205 causes the operating unit 204 to display a printing setting user interface for case binding illustrated in FIG. 14. Then, at a timing in which the operator selects “form spine” 2601 (FIG. 14), the controller unit 205 performs a controlling operation so as to cause the operating unit 204 to display a spine setting user interface for the case binding illustrated in FIG. 15. Then, the controller unit 205 receives a setting of the spine from the spine setting user interface for the case binding, shown in FIG. 15.

When the operator is to form a spine for the case binding, at a setting column 2701 related to setting a spine width in the spine setting user interface for the case binding (shown in FIG. 15), a setting operation related to the spine width corresponding to the interval between the back-cover image and the front-cover image at the perfect-bound-cover sheet is performed. In the method of setting the spine width, two modes, that is, a manual mode and an automatic mode are provided. Accordingly, a user can select either one of these modes, and the controller unit 205 performs a controlling operation so that the processing is performed for the case-binding job in accordance with the selected mode.

When the user selects the manual mode, the user manually sets a spine-width size (spine width) corresponding to the interval between front-cover print data and back-cover print data, provided on the same face as that of one sheet used as a cover. The set value is set as a result of the user inputting an explicit numeral value using, for example, the numerical keypad. When the manual mode is used, the manual mode can be specified by checking a setting column 2703 by a user operation. Then, the user can manually set the spine width through a setting column 2705.

In contrast, when the user selects the automatic mode, the spine width is automatically set, in which case the user does not manually set the spine width. For example, the controller unit 205 automatically sets this value by a method that is described below. The automatic mode can be used by checking a setting column 2702 by a user operation.

The spine width specified and either automatically or manually set is controlled so as to be displayed in a display column 2704. This allows the user to confirm the set spine width.

Accordingly, the controller unit 205 receives various settings related to printing of the cover in the case-binding job from the user through the user interface unit, and performs controlling operations in accordance with the received setting/settings.

When the automatic mode is specified by the selection of the setting column 2702, the controller unit 205 checks two types of information, that is, the thickness of one sheet used in a text sheet bundle in the job, and the total number of sheets of one sheet set (one sheet bundle) used as the text sheet bundle in the job. Then, on the basis of these items of information, the controller unit 205 automatically calculates the aforementioned spine width. Thereafter, the controller unit 205 automatically sets the spine width for the job in which the automatic mode is specified, to cause the setting result to be displayed in the display column 2704. Then, the controller unit 205 generates a print job so that, when printing is executed, the front-cover image and the back-cover image are disposed at the perfect-bound-cover sheet in accordance with the spine width. The automatically calculated thickness of one sheet bundle may be calculated from the thickness of one sheet and the number of pages of print data, or may be calculated by other methods. Accordingly, in the embodiment, a job whose processing is requested when the automatic mode is specified as a processing condition of the job in which the case binding is to be executed, corresponds to a job for automatically forming the cover. From information concerning the job processing condition, the controller unit 205 obtains information specifying the thickness of one set of text sheet bundle. In addition, the controller unit 205 controls the system 1000 so that the front-cover data (corresponding to first print data) and the back-cover data (corresponding to second print data) can be provided on the same face as that of the perfect-bound-cover sheet so as to be separated from each other by the interval based on the thickness of the one set of text sheet bundle. Accordingly, a layout of the data of the cover sheet is automatically determined without the reception of manual setting of the spine width from the operator through the UI unit. In the embodiment, the printing apparatus 100 can receive, as a cover automatic formation job, the job that is required to execute the formation of the cover and that is executed in the case-binding operation.

In contrast, when the manual mode is specified by the selection of the setting column 2703, the controller unit 205 detects the value of the spine width manually input at the setting column 2705 by the operator. Then, the controller unit 205 generates a print job so that the front-cover image and the back-cover image are provided at the perfect-bound-cover sheet in accordance with the manually set spine width. Accordingly, in the embodiment, a job whose processing is requested when the manual mode is specified as a processing condition of the job in which the case binding is to be executed, corresponds to a job for manually forming the cover. The controller unit 205 controls the system 1000 so that the front-cover data (corresponding to the first print data) and the back-cover data (corresponding to the second print data) can be provided on the same face as that of the perfect-bound-cover sheet so as to be separated from each other by the interval of the set amount based on the manual setting of the operator received through the UI unit. Accordingly, a layout of the data of the perfect-bound-cover sheet is automatically determined on the basis of the spine width received by the manual setting of the operator through the UI unit. In the embodiment, the printing apparatus 100 can receive, as a cover manual formation job, the job that is required to execute the formation of the cover and that is executed in the case-binding operation.

When the controller unit 205 detects that the operator has selected a button 2706, the controller unit 205 sets the automatically calculated spine width at the setting column 2705.

Accordingly, the controller unit 205 performs the series of operations including the detection of the input of the setting of the spine by the user in Step S2204.

Next, in Step S2205, the controller unit 205 detects whether or not the operator has given a print instruction (execution instruction) of the job, by determining whether or not the key 503 is pressed.

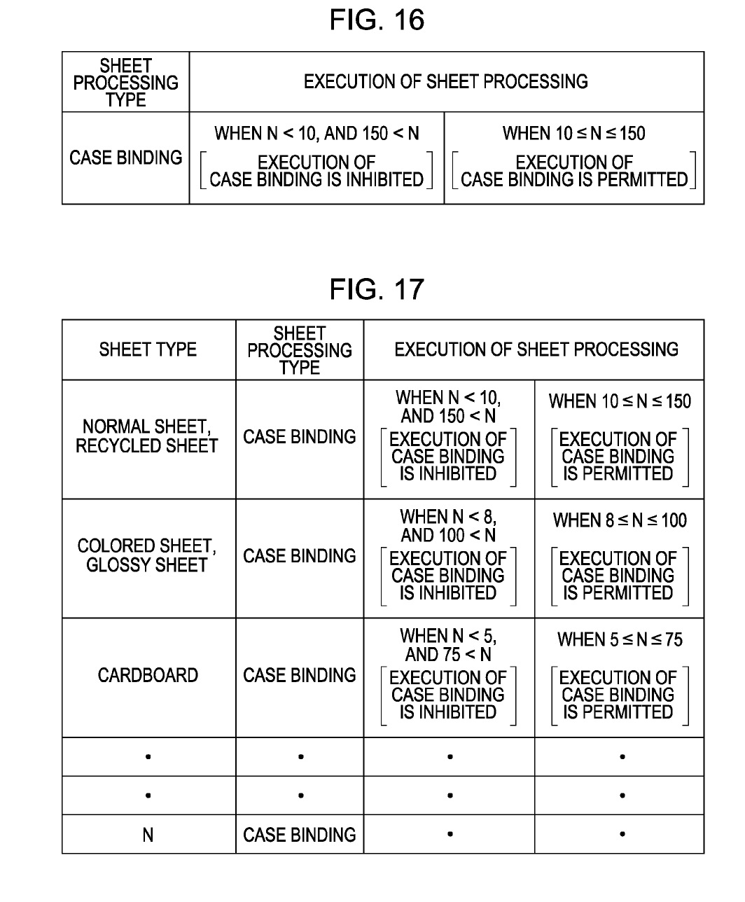

Next, in Step S2206, the controller unit 205 determines whether or not the total number of sheets of one text sheet bundle for the detected (received) case-binding job is within the range of number of sheets permitted for performing the case-binding on the basis of the mechanical restrictions of the case-binding apparatus. Exemplary control information tables used by the controller unit 205 when determining whether or not the number of sheets permits the case binding by the case-binding apparatus are shown in FIGS. 16 and 17.

FIG. 16 shows an exemplary control information table including conditions used by the controller unit 205 to determine whether or not to permit the case binding by the case-binding apparatus, when the sheet type used for the text of the job is not considered. In the table, the number of sheets for the text is represented as a variable N.

In the example using the control information table shown in FIG. 16, when the number of sheets for the text of the job is not within the range of from 10 to 150 sheets, the controller unit 205 determines that the case-binding apparatus cannot properly perform the case-binding operation, in accordance with the control information table shown in FIG. 16. In this case, the controller unit 205 inhibits the case-binding operation for the job. In contrast, when the number of sheets for the text of the job is within the range of from 10 to 150 sheets, the controller unit 205 determines that the case-binding apparatus can properly perform the case-binding operation. The upper limit and the lower limit of the number of sheets for the text are not limited to those in FIG. 16, so that other values may be arbitrarily used.

FIG. 17 shows an exemplary control information table including conditions used by the controller unit 205 to determine whether or not to permit the case binding by the case-binding apparatus, when the sheet type used for the text of the job is considered. In the table, the number of sheets for the text is represented as a variable N.

In the example using the control information table shown in FIG. 17, when the text of the job uses a normal sheet, and when the number of sheets for the text of the job is not within the range of from 10 to 150 sheets, the controller unit 205 determines that the case-binding apparatus cannot properly perform the case-binding operation. In this case, the controller unit 205 inhibits the case-binding operation for the job. In contrast, when the number of sheets for the text of the job is within the range of from 10 to 150 sheets, the controller unit 205 determines that the case-binding apparatus can properly perform the case-binding operation.

When the text of the job uses a colored sheet or a glossy sheet, and when the number of sheets for the text of the job is not within the range of from 8 to 100 sheets, the controller unit 205 determines that the case-binding apparatus cannot properly perform the case-binding operation. In this case, the controller unit 205 inhibits the case-binding operation for the job. In contrast, when the number of sheets for the text of the job is within the range of from 8 to 100 sheets, the controller unit 205 determines that the case-binding apparatus can properly perform the case-binding operation.

When the text of the job uses a cardboard, and when the number of sheets for the job is not within the range of from 5 to 75 sheets, the controller unit 205 determines that the case-binding apparatus cannot properly perform the case-binding operation. In this case, the controller unit 205 inhibits the case-binding operation for the job. In contrast, when the number of sheets for the job is within the range of from 5 to 75 sheets, the controller unit 205 determines that the case-binding apparatus can properly perform the case-binding operation.

The upper limit and the lower limit of the number of sheets for the text are not limited to those in FIG. 17, so that other values may be arbitrarily used.

The types of sheets used in the control information table are not limited to those in FIG. 17, so that other sheet types may be arbitrarily used.

Accordingly, the controller unit 205 determines whether or not the total number of sheets of one text sheet bundle for the received case-binding job is within the range of the number of sheets permitted by the case-binding apparatus (Step S2206). Accordingly, in Step S2206, the controller unit 205 operates as a first checker that determines whether or not to execute the case binding.

When, in Step S2206, the controller unit 205 determines that the number of sheets for the text of the job is not within the range of the number of sheets that permits the case-binding operation by the case-binding apparatus, the controller unit 205 causes the process to proceed to Step S2207. In Step S2207, the controller unit 205 inhibits the case-binding operation of the job.

When, in Step S2206, the controller unit 205 determines that the number of sheets for the text of the job is within the range of the number of sheets permits the case-binding operation by the case-binding apparatus, the controller unit 205 causes the process to proceed to Step S2208.

In Step S2208, the controller unit 205 determines whether or not the aforementioned manual mode is specified for the job as a result of checking whether the operator has selected the setting (specifying) column 2073. Accordingly, the controller unit 205 determines whether or not the case-binding job to be processed is a cover manual formation job on the basis of the specification from the user interface unit.

When, in Step S2208, the controller unit 205 determines that the job is a cover automatic formation job in which the automatic mode is specified by the selection of the setting (selecting) column 2702, the controller unit 205 causes the process to proceed to Step S2209.

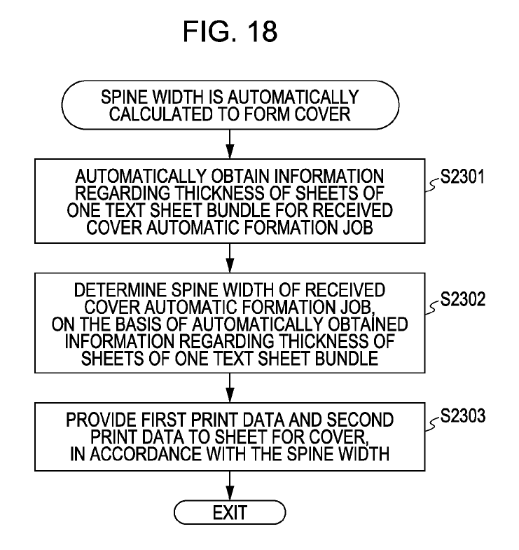

In Step S2209, the controller unit 205 automatically determines the position of the layout of the front-cover image (front-cover data) and the back-cover image (back-cover data) on the same face as that of the cover in the case binding. Accordingly, the controller unit 205 controls the printer unit 203 so that the two items of print data are printed on the same face as that of the cover so as to be separated by the interval corresponding to the spine width automatically determined by the controller unit 205 (the details are shown in FIG. 18). Then, when the operation of Step S2209 is completed, the controller unit 205 ends the controlling process of the flowchart.

Here, with reference to FIG. 18, the operation of automatically disposing the front-cover image and the back-cover image at the perfect-bound-cover sheet (Step S2209 in FIG. 12) will be described in detail.

FIG. 18 shows an exemplary flowchart of a second controlling operation procedure in the embodiment. The steps of the flowchart are performed as a result of the controller unit 205 of the printing system 1000 shown in FIG. 2 reading out and executing a program for executing the controlling process flowchart of FIG. 18. The program is previously stored in a memory (storage medium such as the HDD 208) as a computer program that can be read by a computer. In FIG. 18, S2301 to S2303 denote the steps of the controlling process.

First, in Step S2301, the controller unit 205 automatically obtains information regarding the thickness of the sheets of one text sheet bundle of the job. The controller unit 205 may automatically obtain (calculate) the information regarding the thickness of the sheets of one text sheet bundle from, for example, the thickness of one sheet and the number of sheets to be printed, or the thickness of one sheet and the number of pages of print data. These items of information are based on, for example, information regarding the print condition (such as setting a print sheet received from the user interface unit or setting whether or not one-sided printing is performed) and the total number of pages of print data for one set of text for the job stored in the HDD 209.

Next, in Step S2302, the controller unit 205 automatically determines (calculates) the spine width of the received print job in accordance with the information regarding the thickness of the sheets of the one text sheet bundle automatically obtained (calculated) in Step S2301.

Next, in Step S2303, the controller unit 205 performs a controlling operation so that the case-binding printing operation is executed as a result of automatically disposing the front-cover image (first print data) and the back-cover image (second print data) at the perfect-bound-cover sheet of the job in accordance with the automatically determined (calculated) spine width. When the operation of Step S2303 is completed, the controller unit 205 ends the controlling process of the flowchart.

The description of the flowchart of FIG. 12 will now be continued below.

When, in Step S2208, the controller unit 205 determines that the job is a cover manual formation job in which the manual mode is specified by the selection of the selection column 2703, the controller unit 205 causes the process to proceed to Step S2210.

In Step S2210, the controller unit 205 obtains (confirms) the spine width manually set by the operator through the setting column 2705 for the job.

Concurrently with this, in Step S2211, the controller unit 205 automatically obtains the information regarding the thickness of one text sheet bundle of the job. The controller unit 205 may automatically obtain (calculate) the information regarding the thickness of the sheets of one text sheet bundle from, for example, the thickness of one sheet and the number of sheets to be printed, or the thickness of one sheet and the number of pages of print data.

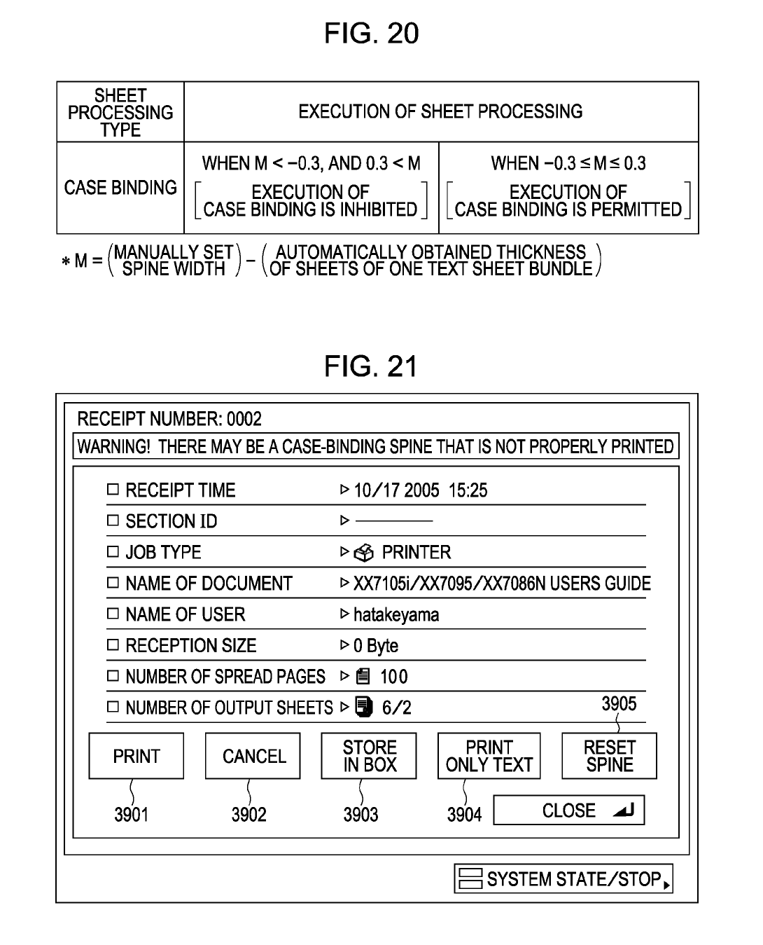

The case-binding job to be processed is a cover manual formation job, and is an example requiring 100 normal sheets as one set of text sheet bundle. Each normal sheet has a thickness of 0.1 mm. This job is permitted on the basis of the rules specified in the control tables of FIGS. 16 and 17 (that is, first rule information controlled at first control tables). That is, it is a job corresponding to “YES” in Step S2206 and “YES” in Step S2208. The thickness of the sheets of one text sheet bundle of the job is: 100 sheets×0.1 mm=10.0 mm. The controller unit 205 compares this value of 10.0 mm with the spine width set at the setting column 2705. Here, the rules specified in the control table of FIG. 20 (described later) (that is, second rule information controlled at a second control table) are applied. On the basis of this result, the controller unit 205 finally determines whether or not the printer unit 203 and/or the sizing/binding apparatus 200 are/is permitted to or inhibited from performing the operations of the case-binding job. In the embodiment, Step S2211 is provided so that the controller unit 205 can perform such series of determinations and controlling operations.

Next, in Step S2212, the controller unit 205 compares the interval corresponding to the spine width manually set for the job (that is, the information obtained in Step S2210 and numerically indicating the size of the spine region in the widthwise direction) with the aforementioned automatically obtained (calculated) information regarding the thickness of one text sheet bundle (that is, the information obtained in Step S2211 and numerically indicating the thickness of the sheets of one text sheet bundle. By this, when the text is covered using the perfect-bound-cover sheet in which the front-cover image and the back-cover image are laid out so as to be separated by the interval corresponding to the spine width manually set by the user, the controller unit 205 determines whether a proper case-binding print result is obtained, to determine whether to permit or inhibit the execution of the case binding for the job, on the basis of the determination result. Accordingly, in the manual mode, the controller unit 205 determines whether a mismatch has occurred between the thickness of one book of text and the size of the spine region at the manually set cover. Accordingly, in Step S2212/S2213, the controller unit 205 also operates as a second checker that determines whether or not to execute the case binding.

That is, if the case-binding job to be processed is a cover manual formation job, the controller unit 205 performs two types of checking operations in Steps S2206 and S2212/2213 for determining whether or not to execute the case binding.

In contrast, if the job to be processed is a cover automatic formation job, the controller unit 205 performs the checking once for determining whether or not to execute the case binding in Step S2206. That is, in the cover automatic formation job, the process can proceed to the following steps without undergoing double checking as in the cover manual formation job.

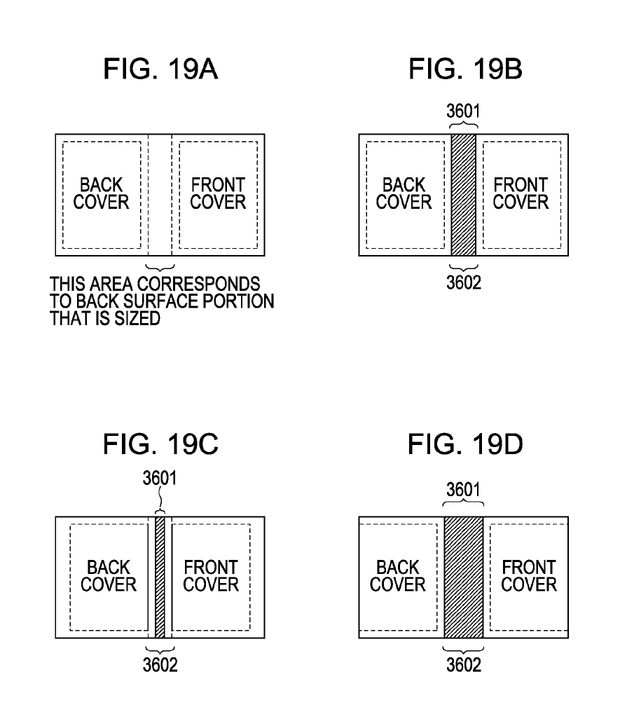

Here, with reference to FIGS. 19A to 19D, the features of determining whether or not the aforementioned proper case-binding printing result is obtained (that is, determining whether a mismatch occurs between the thickness of one book of text and the size of the manually set spine region at the cover) will be illustrated below.

First, FIG. 19A shows an example in which a back-surface location is sized, and FIG. 19B shows an example in which the proper case-binding printing result can be obtained. In the case in which the mismatch does not occur, the printer unit 203 prints the two items of print data of the front cover and the back cover on the same face as that of one sheet serving as a cover in the case binding. On the same face, a front-cover region, a spine region, and a back-cover region are divided. The front cover data for the case-binding job is printed on the front-cover region, and the back-cover data is printed on the back-cover region.

In the example shown in FIG. 19B, a manually set spine width 3601 and a thickness 3602 of the one text sheet bundle are equal to each other. Therefore, when the text sheet bundle is covered by the perfect-bound-cover sheet, the text sheet bundle is sized without the text sheets protruding from the portion having a spine width equal to the manually set spine width and without the spine width being larger than the thickness of the one text sheet bundle. Therefore, the case-binding printing result in accordance with the intentions of the operator can be obtained. Accordingly, FIG. 19B shows a cover print result in which, in the cover manual formation job, a mismatch does not occur between the thickness of one book of text and the manually set size of the spine region at the cover.

FIGS. 19C and 19D show examples in which the case-binding printing result is not proper. That is, in the cover manual formation job, the cover printing result is one in which a mismatch occurs between the thickness of one book of text and the manually set size of the spine region at the cover. In the embodiment, the controller unit 205 controls the printer unit 203 and/or the sizing/binding apparatus 200 so that, in the case-binding job providing such a printing result, operations (such as cover printing, text sheet bundle printing, and case binding) requested in the job are inhibited.

In FIG. 19C, the thickness 3602 of the one text sheet bundle is too large with respect to the manually set spine width 3601. Therefore, when the text sheet bundle is covered by the perfect-bound-cover sheet, the front-cover image and the back-cover image are printed towards the spine. In the embodiment, the controller unit 205 performs a controlling operation so that such a product is not accidentally produced by the printing system 1000.

In FIG. 19D, the thickness 3602 of the one text sheet bundle is too small with respect to the manually set spine width 3601. Therefore, when the text sheet bundle is covered by the perfect-bound-cover sheet, the front-cover image and the back-cover image are printed away from the spine. In the embodiment, the controller unit 205 performs a controlling operation so that such a product is not accidentally produced by the printing system 1000.

In Step S2212/Step S2213, the controller unit 205 uses the information of the control information table that controls data serving as a reference for determining whether or not a proper case-binding printing result is obtained (that is, a reference for determining whether the aforementioned mismatch occurs). This control table is shown in FIG. 20.

In accordance with the control information table in FIG. 20, the controller unit 205 compares the spine width, manually set at the setting column 2705, and the thickness of the sheets of one text sheet bundle for the job, to determine a difference M corresponding to the difference (error) between these compared values.

If the calculated M value is within 0.3 mm, that is, if −0.3≦M≦0.3, the controller unit 205 determines that a proper case-binding print result is obtained (that is, a mismatch does not occur between the thickness of one book of text and the manually set size of the spine region). In this case, the controller unit 25 permits the case binding to be performed for the job (“YES” in Step S2213), so that, for the job, the printing system 1000 successively performs three processing operations, that is, text printing, cover printing, and case binding using these print results.

In contrast, if the calculated M value goes beyond 0.3, that is, if M<−0.3 or 0.3<M, the controller unit 205 determines that an improper case-binding print result is obtained (that is, a mismatch occurs between the thickness of one book of text and the manually set size of the spine region). In this case, the controller unit 205 inhibits the case binding to be performed for the job (“NO” in Step S2213), so that the job is cancelled without successively performing the three processing operations for the job by the printing system 1000.

In the embodiment, the reference of determination of the difference between the spine width, manually set by the user at the setting column 2705, and the thickness of one text sheet bundle, calculated by the controller unit 205 on the basis of the thickness of one sheet and the number of text sheets of one set used in the job, is ±0.3 mm. However, the reference of determination of the difference value is not limited to 0.3, so that any numerical value may be used, or a value serving as the reference for determination may be manually set. As long as the structure is such that the controller unit 205 can inhibit the user from accidentally forming a print product, such as that shown in FIG. 19C or FIG. 19D, that is not intended by the user, any structure can be applied.

Accordingly, in accordance with the rules of the control table shown in FIG. 20, the controller unit 205 determines again in Step S2213 whether to permit or inhibit the execution of the case binding for the job that is determined as being a cover manual formation job in Step S2208.

For the job in which the case binding is permitted in Step S2213, the process proceeds to Step S2215.

In Step S2215, the controller unit 205 permits the execution of the case binding for the job, and the controlling process of the flowchart is ended. In this case, as mentioned above, the controller unit 205 causes the printer unit 203 to successively perform cover data printing and text data printing of the job, so that the sizing/binding apparatus 200 is caused to perform the case binding using these printing results.

In contrast, for the job in which the case binding is inhibited in Step S2213, the process proceeds to Step S2214. In this case, the controller unit 205 inhibits the execution of the case binding for the job, and ends the controlling process of the flowchart.

At a timing in which the controller unit 205 inhibits the execution of the case binding (such as in Step S2214), the controller unit 205 performs a controlling operation so that the user interface unit (the operating unit 204 in the example) provides a case-binding-job confirmation user interface shown in FIG. 21. When the determination is “YES” in Step S2213, a structure that gives warning information may be included. In addition, the following structure may be included.

For example, in Step S2214, as shown in FIG. 21, the controller unit 205 performs a controlling operation so as to display the user interface having a structure for giving out warning information and keys 3901 to 3905 as a structure for inputting an instruction from an operator.

If the controller unit 205 detects that the operator has selected the key 3901, the controller unit 205 performs a controlling operation so as to continue the processing of the job. That is, warning the user that the book may be in the state shown in FIG. 19C or FIG. 19D, if the user still wants the case binding to be executed for the job, the controller unit 205 controls the printing system 1000 so that the case binding is executed for the job.

If the controller unit 205 detects that the operator has selected the key 3902, the controller unit 205 performs a controlling operation so as to cancel the job.

If the controller unit 205 detects that the operator has selected the key 3903, the controller unit 205 performs a controlling operation so that this job (such as print data) is stored in a storage unit (HDD 209).

If the controller unit 205 detects that the operator has selected the key 3904, the controller unit 205 performs a controlling operation so that the printer unit 203 prints only the text of the job.

If the controller unit 205 detects that the operator has selected the key 3905, the controller unit 205 makes it possible for the user to reset the spine width of the job through the user interface unit. For example, in response to the pressing of the key 3905, the controller unit 205 causes the user interface unit (the operating unit 204 in the example) to re-display the spine setting user interface shown in FIG. 15. In addition, the controller unit 205 performs a controlling operation to make it possible for the user to re-set the spine on the user interface.

If the operator resets the spine upon reception of the instruction of the key 3905, the controller unit 205 uses the front-cover image data and the back-cover image data prior to the expansion of, for example, a raster image processor (RIP) (that is, the front-cover data and the back-cover data prior to conversion to bit map image data), to cause the printing apparatus 100 to dispose the images with respect to the cover on the basis of the re-setting. Accordingly, in this case, processing of the layout of the perfect-bound-cover image, in which these items of data are disposed so as to be separated by the interval corresponding to the spine width reset by the user, is executed. By this, the controller unit 205 performs a controlling operation so as to execute the case binding for the cover manual formation job in which the spine width is re-adjusted by the user. However, here, it is presupposed that re-determination is performed in Step S2213 and that the process proceeds to Step S2215.

Here, the cover image prior to RIP may be, for example, stored in the HDD 209 or RAM 208, re-input by the scanner unit 201, or obtained by an external apparatus through the external I/F 202.

Although not illustrated in the embodiment, a key for instructing printing only on the cover for the job and for instructing not to process the text may be further provided on the user interface shown in FIG. 21. If this key is pressed, the controller unit 205 controls the printer unit 203 so that the printer unit 203 prints only the cover for the job.

After the controller unit 205 performs a controlling operation so that the case binding for the job is inhibited in Step S2214 shown in FIG. 12, the following may be performed. That is, on the basis of the thickness of the one text sheet bundle, the controller unit 205 automatically changes the spine width of the perfect-bound-cover sheet for the job into a value that provides a proper case binding result. Then, in accordance with the automatically changed setting, raster image processing is performed again on the image of the perfect-bound-cover sheet, to re-start the case-binding printing operation using the perfect-bound-cover sheet.

In the case binding printing operation, the sizing unit shown in FIG. 5 is caused to execute sizing on a sheet bundle comprising a plurality of text sheets on which text print data is printed (this sheet bundle is called a first-type sheet bundle). In the sizing operation, the plurality of text sheets (first-type sheets) are sized to each other.

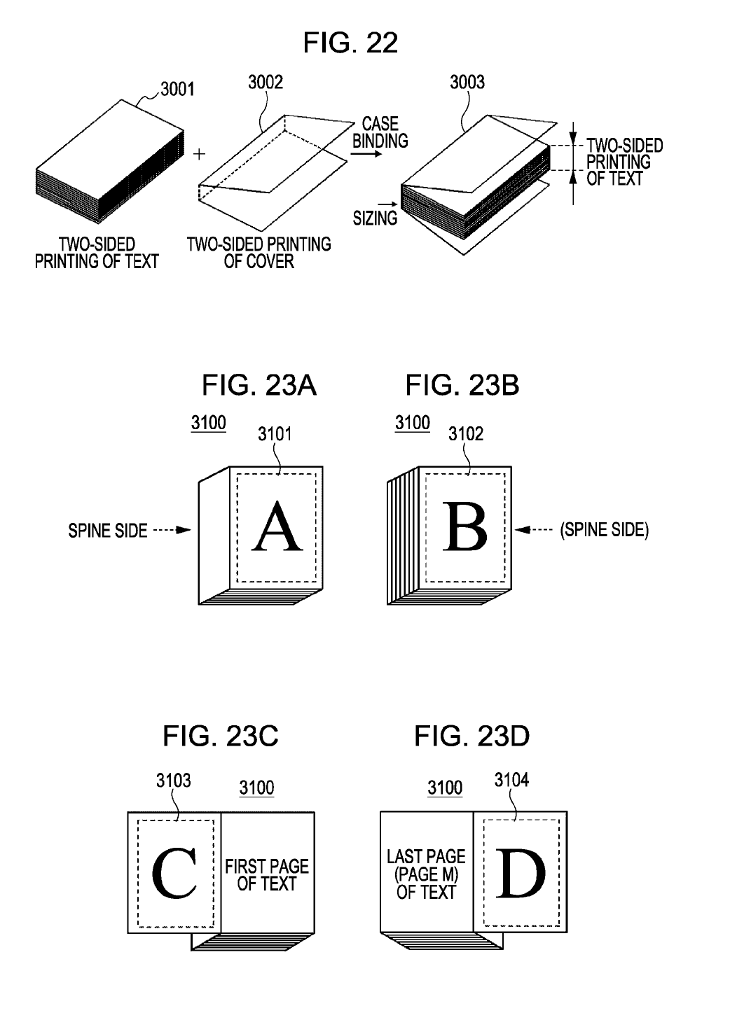

In the case binding, the first-type sheets in which this sizing operation is completed (that is, the sheet bundle comprising the plurality of text sheets on which text image data is printed) and a predetermined type of sheet (second-type sheet) specified by the user as a perfect-bound-cover sheet are provided as one output bundle, to size the sheets by the sizing unit shown in FIG. 5. An example represented by reference numeral 3002 shown in FIG. 22 is a perfect-bound-cover sheet (corresponding to the second-type sheet). An example represented by reference numeral 3001 shown in FIG. 22 is a text sheet bundle for the job. A case-binding result, which is a final product, using these sheets is represented by reference numeral 3003.

In the embodiment, the first-type sheet bundle (corresponding to the sheet bundle on which text image is printed) and the second-type sheet (corresponding to a perfect-bound-cover sheet for covering the text sheet bundle) can be sized by any method.

However, the controller unit 205 controls the printing system 1000 so that a proper case-binding result (final product), like a printed product 3100 illustrated in FIGS. 23 to 27, in which the aforementioned mismatch does not occur, is finally obtained.

In the printing system 1000 according to the embodiment, the second-type sheet (corresponding to a perfect-bound-cover sheet) is fed from the sheet-feed unit specified by the user from among the plurality of sheet-feed units (represented by reference numerals 317, 318, 319, and 320 in FIG. 3) of the printing apparatus 100, so that it can be conveyed to the interior of the sheet processing apparatus 200.

The printing system 1000 is constructed so that the printer unit 203 can print perfect-bound-cover image data onto the second-type sheet (corresponding to a perfect-bound-cover sheet).

In the embodiment, the controller unit 205 performs a controlling operation so that an operation user interface for making it possible for the user to determine whether or not to print perfect-bound-cover image data in the case-binding operation on the second-type sheet can be displayed on the operating unit 204. In addition, through, for example, the operation user interface, the user can select whether or not to execute printing on the second-type sheet in a case-binding mode. If printing is not required, the controller unit 205 may perform a controlling operation so that a sheet on which a cover image is previously printed is directly supplied to the sizing unit from the inserter shown in FIG. 5. Alternately, it may perform a controlling operation so that the sheet is passed through the printer unit 203 without performing printing, and supplied to the sizing unit shown in FIG. 5.

The relationship between the first-type sheet and the second-type sheet in the case-binding operation in the embodiment will be described.

In the embodiment, the first-type sheet and the second-type sheet may be different types of sheets having have different sizes. Alternately, they may be the same type of sheets having different sizes. That is, the first-type sheet and the second-type sheet in the case-binding mode described in detail in the embodiment at least have different sizes. In particular, in the embodiment, the second-type sheet is larger than the first-type sheet.

The sizing operation of the first-type sheet and the second-type sheet is carried out as follows.

For example, the second-type sheet on which perfect-bound-cover image data is printed is sized to the first-type sheet bundle on which text image data is printed and which is sized to the spine, so that the second-type sheet completely covers the first type of sheet bundle with the spine of the first-type sheet bundle serving as a center. Then, finally, the second-type sheet is folded with the spine serving as the center. This exemplary output result corresponds to the exemplary print results shown in FIGS. 23 to 27.

Reference numeral 3101 shown in FIGS. 23 to 27 denotes an example in which an image A, serving as front-cover data, is printed onto a front-cover region (corresponding to the region labeled “front cover” in FIG. 19B) on the same face as that of one perfect-bound-cover sheet.

Reference numeral 3102 shown in FIGS. 23 to 27 denotes an example in which an image B, serving as back-cover data, is printed onto a back-cover region (corresponding to the region labeled “back cover” in FIG. 19B) provided on the same face. Reference numeral 3103 shown in FIGS. 23C to 27C denotes an example in which an image C is printed onto a reverse side of the side where the image A is printed. Reference numeral 3104 shown in FIGS. 23D to 27D denotes an example in which an image D is printed onto a reverse side of the side where the image B is printed.

As described above, according to the present invention, the problems of the related art can be overcome. For example, it is possible to provide a printing environment that is applicable to and that can be easily used not only in an office environment, but also in a POD environment. For example, the present invention makes it possible to meet the needs in an actual working place in a printing environment (such as a POD environment), such as the need for operating a system having high productivity to the extent possible, or the need for minimizing the workload on an operator. In particular, the present invention provides the following advantages.

For example, it is possible to perform the case-binding operation so as to restrict the production of an unintended output result when a text printed material is covered with the perfect-bound-cover sheet when a mismatch occurs between the thickness of one text sheet bundle of printed material and the interval between the front-cover image and the back-cover image laid out on the perfect-bound-cover sheet.

Accordingly, it is possible to provide a convenient and flexible environment that can meet the needs and use cases in the POD environment, such as those in the related art.

### Additional Structure

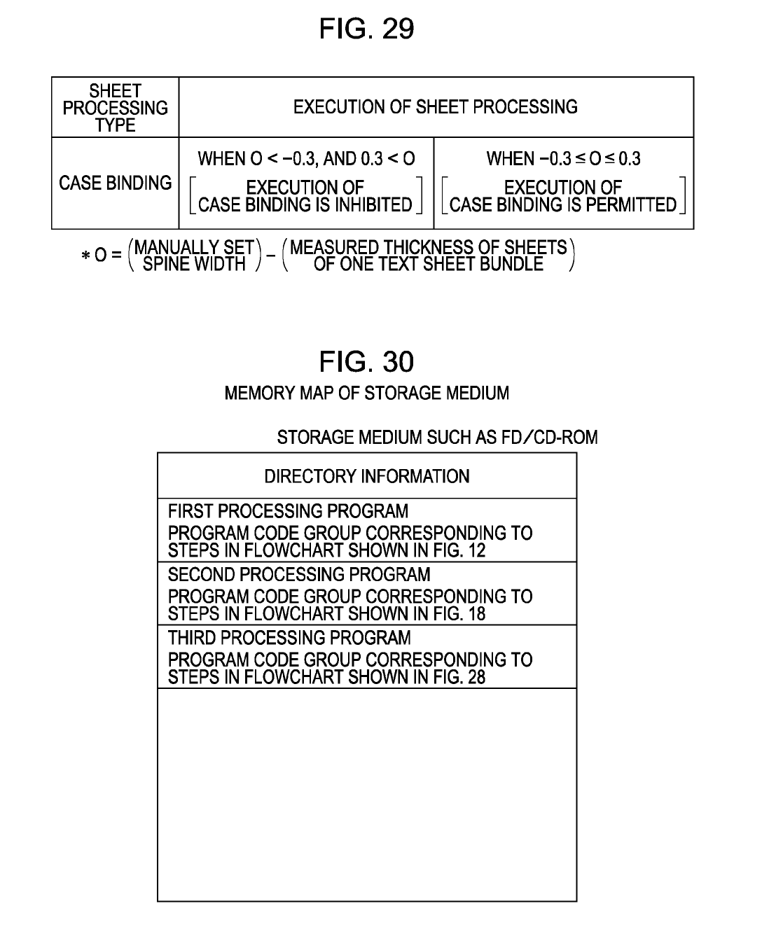

An additional structure that can be provided by the printing system, which is applicable as a modification of the above-described structure, will now be described with reference to FIGS. 28 and 29. In the previously described structure, the thickness of a sheet bundle is calculated by the controller unit 205 from the total number of print sheets per one book and required in one text sheet bundle and from the thickness of one print sheet of the sheet bundle. In contrast, in this structure, the printer unit 203 actually performs printing on the text sheet bundle, to actually measure the thickness of the one sheet bundle with a measuring unit.

FIG. 28 is an exemplary flowchart of a third controlling operation procedure in the embodiment. Even here, the steps of the flowchart are performed as a result of the controlling unit 205 of the printing system 1000 shown in FIG. 2 reading out and executing a program for executing the controlling process flowchart of FIG. 28. The program is previously stored in the memory (storage medium such as the HDD 208 or HDD 209) as a computer program that can be read by a computer. In FIG. 28, S2201 to S2210, S2213 to S2215, and S2411 to S2413 denote the steps of the controlling process. These steps are the same as those in FIG. 12, will be given the same step numbers, and will not be described below.

Since the operations in Steps S2201 to S2210 are the same as those in FIG. 12, the description thereof will be omitted.

When, in Step S2210, the controller unit 205 obtains a spine width that is set by an operator through the setting column 2705 for a received case-binding job, the process proceeds to Step S2411.

In Step S2411, the controller unit 205 performs a controlling operation so that the printer unit 203 prints one set of text sheet bundle required for the case-binding job.

Next, in Step S2412, the controller unit 205 performs a controlling operation so that the thickness of the one printed text sheet bundle is measured with the measuring unit. In measuring the thickness of the one text sheet bundle, a member that holds the text sheet bundle and that is disposed near the stacking unit in the sizing/binding apparatus shown in FIG. 5 is made to function as the measuring unit, to measure the thickness by making use of a grip pressure of this member on the text sheet bundle. However, this member is only an example of the measuring unit, so that the measuring unit is not particularly limited. The thickness of the text sheet bundle can be measured by other methods. The thickness of the one text sheet bundle can be measured all at once after printing the entire one text sheet bundle. Alternatively, it can be measured by measuring the thickness of each sheet and adding the thicknesses of all the sheets. Accordingly, any method can be used to actually measure the thickness of the one text sheet bundle, which is compared with the spine width manually set by the user.

Next, in Step S2413, the controller unit 205 determines whether or not the above-described mismatch has occurred from the spine width manually set for the case-binding job at the setting column 2705 and the thickness of the one text sheet bundle of the job corresponding to the result of the actual measurement in Step S2412. On the basis of this determination, the controller unit 205 determines whether to permit or inhibit the case-binding operation for the job.

Whether or not a proper case-binding printing result is obtained can be determined by the controller unit 205 as illustrated in FIGS. 19A to 19D, so that this will not be described.

A control information table serving as a reference when the controller unit 205 determines whether or not a proper case-binding print result is obtained using an actually measured value is illustrated in FIG. 29.

In accordance with the control information table shown in FIG. 29, the controller unit 205 compares the spine width manually set at the setting column 2705 and the actually measured thickness of the one text sheet bundle for the job, to determine a difference O, which is a value corresponding to this difference (error).

If the calculated value O is within 0.3 mm, that is, when −0.3≦O≦0.3, the controller unit 205 determines that a proper case-binding print result is obtained (that is, it determines that a mismatch has not occurred between the manually set size of the spine region and the thickness of one text book). In this case, the controller unit 205 permits the case binding for the job (the process proceeds from Step S2213 to Step S2215 in FIG. 28). In addition, in this case, the printing of the text for the job is completed. Therefore, in this case, the controller unit 205 performs a controlling operation so that the printing system 1000 continues the remaining operations that need to be performed subsequent to the printing of the text in this job. That is, the controller unit 205 causes the printing system 1000 to perform cover printing if the cover printing is not completed. Then, it causes the printing system 1000 to perform the case binding by the sizing/binding apparatus 200.

In contrast, if the calculated difference O goes beyond 0.3 mm, that is, when O<−0.3 or 0.3<O, the controller unit 205 determines that an improper case-binding print result is obtained (that is, it determines that a mismatch occurs between the manually set size of the spine region and the thickness of one text book). In this case, the controller unit 205 inhibits the case binding for the job (the process proceeds from Step S2213 to Step S2214 in FIG. 28). In addition, in this case, the printing of the text for the job is completed. Therefore, in this case, the controller unit 205 performs a controlling operation so that the processing is stopped at this point without continuing the remaining operations that need to be carried out subsequent to the text printing in this job. By this, the controller unit 205 can inhibit the execution of the case binding without proceeding to the case-binding operation performed by the sizing/binding apparatus 200.

The value O in FIG. 29 may be handled in the same way as in the illustration shown in FIG. 20. For example, any numerical value other than 0.3 mm may be used, so that the user can manually set this value using, for example, the aforementioned user interface unit.

Accordingly, the controller unit 205 may determine whether or not to execute the case binding for a cover manual formation job on the basis of a determination using the actually measured value in, for example, Step S2412/Step S2413. The points other than these points can be applied within a scope not contradicting the above-described structure, so that these other points will not be described below.

### Supplementary Description

A supplementary description regarding the various above-described structures will now be given. In the description below, additional structural features that can be applied in common to each of the structures described above will be described.

The controller unit 205 determines that the job to be processed is a cover automatic formation job. In this case, the controller unit 205 does not execute operations for specifying the thickness of one set of text sheet bundle, such as the operation for determining the sheet type, the operation for determining the total number of pages of text sheets, etc., required for completing the printing of the one set of text sheet bundle for the job. In addition, the controller unit 205 does not determine whether to permit or inhibit the execution of the case binding for job on the basis of the information regarding the thickness of the one set of text sheet bundle for the job to be subjected to the case binding.

Accordingly, when the job to be processed is a cover automatic formation job, the controller unit 205 performs a controlling operation so as not to execute the operations that are performed when the job to be processed is a cover manual formation job, such as specifying the thickness of the text sheet bundle and determining whether or not to execute the case binding on the basis of the result thereof. Then, the controller unit 205 causes the printing apparatus 100 to quickly start the cover formation operation of the job.

The printing system 1000 may be formed so that these structural requirements are added to and included in any of the above-described structures.

Accordingly, the advantages of contributing to the maintenance of high productivity and the increase in productivity, which are related to the case-binding job and which may be considered very important in the POD environment in the future, can be enhanced as a result of only executing the necessary operations in the case-binding job.

However, even in the cover automatic formation job, it is desirable to determine whether or not to execute finishing, itself, that is, the case-binding operation on the basis of the total number of sheets required in printing the one set of text sheet bundle. This makes it possible to achieve the aforementioned advantages without the following problems.

The problem that the front-cover image is “swallowed by” the spine, and the problem that the front-cover image is too far from the spine do not occur. However, when printing is performed, an improper printing result, in which the perfect-bound-cover sheet is not properly applied to the text sheet bundle, occurs. As a result, a problem occurs in the post-processing, itself, that is, the case binding.

The advantages that can be achieved by the printing system 1000 according to the above-described embodiment are as follows.

For example, the printing system 1000 can overcome the aforementioned related problems; can produce a convenient printing environment that is applicable and that can be easily used not only in an office environment, but also in a POD environment; and can meet the needs in an actual working place in a printing environment (such as a POD environment), such as the need for operating a system having high productivity to the extent possible, or the need for minimizing the workload on an operator. In particular, the following advantage can be provided.

For example, it is possible to provide an image forming apparatus and an image forming system, which can perform the case-binding operation so as to restrict the occurrence of an unintended output result when a text printed material is covered with a perfect-bound-cover sheet when a mismatch occurs between the thickness of one text sheet bundle of printed material and the interval between a front-cover image and a back-cover image laid out on the perfect-bound-cover sheet.

Accordingly, it is possible to provide a convenient and flexible printing environment that can satisfy the needs and use cases in a POD environment, such as those in the related art. Therefore, various structural features for putting products into actual use can be provided.

### Another Structure

Although, as described above, the operator, for example, can select the binding method or set a spine using the operating unit 204 as a user interface unit for operating the printing system 1000, the present invention is not limited thereto. For example, the user can select the binding method (case binding) and set a spine using a remote user interface provided to an information processing apparatus, such as a host computer (including the PC 103 or the PC 104), to cause the printing system 1000 to carry out a job transmitted from the apparatus in accordance with the setting. In this structure, the controller unit 205 of the printing system 1000 receives the job transmitted from the external apparatus, and executes each step shown in FIG. 12 for the received job.

That is, the controller unit 205 of the printing system 1000 inhibits the execution of the job received from the external apparatus and including the case-binding operation. That is, when the controller unit 205 inhibits the execution of the job including the case-binding operation, the controller unit 205 inhibits the execution of the job after the printing system 1000 receives a print job from the external apparatus.

### Still Another Structure

Although the above-described structures are primarily described so that the controlling operations are mainly performed by the controller unit in the printing apparatus 100, the present invention is not limited thereto. For example, the following is possible. A program that can be executed by a computer for realizing the various above-described structures is installed in an information processing apparatus, such as a host computer (including the PC 103 and the PC 104), from an external data generating source, such as a WEB server. Then, instead of the controller unit 205, the information processing apparatus executes, using this program, the various determination and/or controlling operations executed by the controller unit 205 in the above-described structures. In this case, data for displaying operation user interfaces that are similar to those in the embodiment (including those shown in, for example, FIGS. 10, 13, 14, 15, and 21) is also installed from the external data generating source. This makes it possible to provide various operation user interfaces at a user interface unit of the information processing apparatus, so that the above-described various structures are applied in the job transmitted from the image processing apparatus.

By this, the information processing apparatus inhibits the execution of the job including the case binding and generated at the information processing apparatus. That is, when the execution of the job including the case binding is to be inhibited, the information processing apparatus inhibits the job prior to transmitting the job to the printing system 1000. Accordingly, the printing system 1000 is applicable to such a structure.

The present invention is applicable to such a structure even when an information group including a program is supplied to an output apparatus from a storage medium, such as a CD-ROM, a flash memory, or an FD, or from an external storage medium through a network.

The structure and content of the above-described various data are not limited thereto, so that the various data may, obviously, have various structures and contents in accordance with the use and purpose.

Although one embodiment is described above, the present invention may include other embodiments, such as a system, an apparatus, a method, a program, or a storage medium. More specifically, the present invention may be applied to a system comprising a plurality of apparatuses, or to an apparatus comprising one device.

The structure of a memory map of a storage medium storing various data processing programs that can be read by the printing system according to the present invention will now be described with reference to a memory map shown in FIG. 30.

FIG. 30 illustrates a memory map of a storage medium (recording medium) that stores various data processing programs that can be read by the printing system according to the present invention.

Although not particularly illustrated, information regarding the controlling of the program group that is stored in the storage medium (such as version information and creator), and information regarding how dependent the program read-out side is upon, for example, an OS (such as an icon that identifies and displays a program) may be stored.

Data dependent upon the various programs is also controlled by the aforementioned directory. When a program for installing the various programs in a computer or a program to be installed is compressed, a decompression program or the like may be stored.

A program to which the functions illustrated in FIGS. 12, 18, and 28 in the embodiment are externally installed may be executed by a host computer. In this case, the present invention is applicable even when an information group including a program is supplied to an output apparatus from a storage medium, such as a CD-ROM, a flash memory, or an FD, or from an external storage medium through a network.

Accordingly, the storage medium in which a program code of a software that achieves the functions of the above-described embodiment is stored is supplied to a system or an apparatus. Obviously, the object of the present invention can be achieved as a result of a computer (CPU or MPU) of the apparatus or the system reading out and executing the program code stored in the storage medium.

In this case, the program code read out from the storage medium realizes a novel function according to the present invention, so that the storage medium storing the program code constitutes the present invention.

Any program form, such as script data supplied to an OS, a program executed by an interpreter, or an object code, may be used as long as it includes a program function.

Examples of the storage medium for supplying the program include a flexible disc, a hard disc, an optical disc, a magneto-optical disc, an MO, a CD-ROM, a CD-R, a CD-RW, a magnetic tape, a nonvolatile memory card, ROM, and a DVD.

In this case, the program code read out from the storage medium realizes the aforementioned functions according to the embodiment, so that the storage medium storing the program code constitutes the present invention.

The program may also be supplied by connecting to a homepage on the Internet using a browser of a client computer and downloading to the storage medium (such as a hard disc) the program according to the present invention from the homepage. Alternatively, the program may be supplied by downloading to the storage medium (such as a hard disc) a file compressed from the homepage and including an automatic installing function. Still alternatively, the program may be supplied by dividing the program code of the program according to the present invention into a plurality of files and downloading the files from different homepages. That is, for example, a WWW server and an FTP server that download to a plurality of users program files for realizing the functions according to the present invention by a computer are also included in the claims according to the present invention.

The program according to the present invention is encrypted, stored in the storage medium (such as a CD-ROM), and distributed to users. In addition, key information that decodes the encrypted program is downloaded from a homepage through the Internet to any user that has cleared a predetermined condition. Using the key information makes it possible to execute the encrypted program, and to install the program in a computer.

Obviously, in addition to realizing the functions according to the embodiment by executing the program code read out by the computer, the functions according to the embodiment may be realized as follows. For example, the functions according to the embodiment may be realized as a result of an OS (operating system) operating at the computer performing part of or all of the actual processing operations on the basis of the instruction of the program code.

In addition, the functions according to the embodiment may be realized as follows. A program code read out from the storage medium is written to a memory including a function expansion board, inserted in a computer, or a function expansion unit, connected to the computer. Then, on the basis of the instruction of the program code written to the memory, for example, a CPU including the function expansion board or the function expansion unit performs part of or all of the actual processing operations, to realize the functions.

The present invention may be applied to a system comprising a plurality of apparatuses or to apparatus including one device. In addition, the present invention may obviously be applied to the case in which a program is supplied to the system or the apparatus. In this case, the system or the apparatus can provide the advantages of the present invention as a result of the system or the apparatus reading a storage medium storing a program represented by software for achieving the present invention.

The present invention is not limited to the above-described embodiment, so that various modifications (including organic combinations of the different practical forms of the present invention) are possible within the gist of the present invention, that is, they are not excluded from the scope of the present invention. For example, the present invention includes all cases in which at least one of the above-described structures is included. For example, although, in the embodiment, the controller unit 205 in the printing apparatus 100 mainly performs the various controlling operations, some or all of the various controlling operations can be executed by, for example, an external controller of a housing provided separately from the printing apparatus 100.

Although the embodiments and the embodiment of the present invention have been described, the gist and scope of the present invention are not limited to particular descriptions in the specification.

Structures formed by combinations of the above-described embodiments and modifications thereof are all included within the present invention.

This application claims the benefit of Japanese Application No. 2007-010762 filed Jan. 19, 2007, which is hereby incorporated by reference herein in its entirety.

What is claimed is:

1. A system configured to control at least one of a printer and a binder to perform processing for a case-binding job, the binder being adapted to perform a case binding by using a bundle of sheets and a cover, the cover having a spine region between a front-cover region and a back-cover region on the same face, the printer being adapted to print front-cover data on the front-cover region and to print back-cover data on the back-cover region, a size of the spine region being based on a setting selected by an operator via a user interface, the system comprising:
an inhibiter adapted to inhibit the processing for the case-binding job by at least one of the printer and the binder, when a mismatch between the size of the spine region and thickness of the bundle of sheets is determined; and
a permitter adapted to permit the processing for the case-binding job by at least one of the printer and the binder, when no mismatch between the size of the spine region and thickness of the bundle sheets is determined.

2. The system according to claim 1, wherein, when the mismatch between the size of the spine region and thickness of the bundle of sheets is determined, the inhibiter inhibits the processing for the case-binding job by inhibiting printing of the cover by the printer, and
wherein, when no mismatch between the size of the spine region and thickness of the bundle of sheets is determined, the permitter permits the processing for the case-binding job by permitting printing of the cover by the printer.

3. The system according to claim 1, wherein, when the mismatch between the size of the spine region and thickness of the bundle of sheets is determined, the inhibiter inhibits the processing for the case-binding job by inhibiting attaching of the cover to the bundle of sheets by the binder, and
wherein, when no mismatch between the size of the spine region and thickness of the bundle of sheets is determined, the permitter permits the processing for the case-binding job by permitting attaching of the cover to the bundle of sheets by the binder.

4. The system according to claim 1, wherein the mismatch between the size of the spine region and thickness of the bundle of sheets is determined when an image of the front-cover data or the back-cover data is disposed in the spine region.

5. The system according to claim 1, wherein the mismatch between the size of the spine region and thickness of the bundle of sheets is determined when no image of the front-cover data and the back-cover data is positioned less than a defined distance from the spine region.

6. The system according to claim 1, further comprising another inhibiter adapted to inhibit the processing for the case-binding job by the printer and/or the binder, regardless of whether or not the mismatch occurs, when another mismatch between processing capacity of the binder and the thickness occurs.

7. The system according to claim 1, wherein a plurality of processing operations are performed sequentially by using the printer and the binder, when the processing for the case-binding job is permitted, and
wherein the plurality of processing operations include printing for the bundle of sheets, printing for the cover, and the case binding.

8. The system according to claim 1, wherein the inhibiter cancels printing for the bundle of sheets and/or the cover by the printer, when the mismatch occurs.

9. The system according to claim 1, wherein the inhibiter cancels the case binding by the binder without canceling printing for the bundle of sheets and/or the cover by the printer, when the mismatch occurs.

10. The system according to claim 1, further comprising a checker adapted to check whether the mismatch occurs before performing printing for the bundle of sheets by the printer.

11. The system according to claim 1, further comprising a checker adapted to check whether the mismatch occurs after performing printing for the bundle of sheets by the printer.

12. The system according to claim 1, wherein the inhibiter and/or the permitter are/is utilized when a certain mode is designated by a designator, and
wherein the size of the spine region is determined manually on the basis of the setting by the user interface, in the certain mode.

13. The system according to claim 12, further comprising an enabler adapted to enable the printer and/or the binder to perform the processing for the case-binding job without checking whether the mismatch occurs when another certain mode is designated by the designator,
wherein the size of the spine region is determined automatically on the basis of information about the thickness, in the other certain mode.

14. The system according to claim 1, wherein a certain processing is performed when the processing for the case-binding job is inhibited, and
wherein the certain processing is performed for giving a warning about the case-binding job, changing the setting, storing print data of the case-binding job, or performing printing for the bundle of sheets without performing the case-binding.

15. A program product stored in a computer usable storage medium, the program product including a program code for causing a computer system to perform a method for enabling a printer and/or a binder to perform processing for a case-binding job, the binder being adapted to perform case binding using a bundle of sheets and a cover, the cover having a spine region between a front-cover region and a back-cover region on the same face, the printer being adapted to print front-cover data on the front-cover region and to print back-cover data on the back-cover region, the size of the spine region being based on a setting of an operator by a user interface, the method comprising:
inhibiting the processing for the case-binding job by the printer and/or the binder, when a mismatch between the size of the spine region and thickness of the bundle of sheets occurs; and
permitting the processing for the case-binding job by the printer and/or the binder, when the mismatch does not occur.
